(19) United States
(12) Patent Application Publication
(10) Pub. No.: US 2008/0249819 A1
(43) Pub. Date: Oct. 9, 2008

(54) SUPPORT METHOD AND DESIGN SUPPORT SYSTEM

(76) Inventor: Hiroshi Sato, Yokosuka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/046,601

(22) Filed: Mar. 12, 2008

(30) Foreign Application Priority Data
Mar. 13, 2007 (JP) 2007-062762
Mar. 7, 2008 (JP) 2008-057173

(51) Int. Cl. G06Q 10/00; G06F 17/30; G06F 17/40

(52) U.S. Cl. 705/7

(57) ABSTRACT

To provide a method of an a system for supporting creation of improvement structure to reduce member costs, assembly costs, and losses associated with defective assemblies of a product. Parts constituting a product are analyzed into functions, attributes, assembly operations, and assembly attributes; on the basis of the difference between the member and assembly costs due to presence or absence of these elements, elements requiring improvement are extracted; and improvement guidelines are created using similar improvement examples in the past. It is possible to present improvement guidelines in structure to reduce the member costs and the assembly costs.

### INCORPORATION BY REFERENCE

The present application claims priorities from Japanese applications JP2007-062762 filed on Mar. 13, 2007, JP2008-057173 filed on Mar. 7, 2008, the contents of which are hereby incorporated by reference into this application.

### BACKGROUND OF THE INVENTION

The present invention relates to a method of and a system for supporting design of electric appliances for family use, products for Office Automation (OA), and the like.

In the product design, as a method of supporting member cost reduction design, there has been conventionally proposed, as described for example in JP-A-2002-373182, a method in which materials satisfying design specifications are determined in consideration of environmental costs and exchange rates.

Also, as a member cost reduction design method, there has been proposed a method described, for example, in “Value Engineering” (Yasuhiko Sato, U-LEAG Co. Ltd, 1996) in which functions of constituent parts of a product to be improved are analyzed, and then the constituent part costs are allocated to the functions thereof according to (1) function achievement degree, (2) contribution degree, and (3) equal ratio; the allocated costs are summed up to obtain a total for each function group, functions to be improved are extracted according to the magnitude of the total, and ideas are obtained through the brainstorming or the like.

Moreover, as a method to create an improvement measure to solve a problem, there has been described a method, for example, in “Matrix 2003: Updating the TRIZ Contradiction Matrix” (Darrell Mann, Simon Dewulf, Boris Zlotin, Alla Zusman, CREAX Press, Belgium, 2003 in which by selecting an item to be improved and a problem occurring due to the improvement from a two-element table, an item in which a hint for the improvement measure is guided.

Next, as a method of quantitatively evaluating an assembly time of a constituent part, there has been proposed, as described for example in JP-A-2003-39260, a method in which a product assembly operation is analyzed to calculate an assembly time of each part according to constituent elements of the operation.

Also, as a method of quantitatively evaluating defective assembly potential, there has been proposed, as described for example in JP-A-10-334151, a method in which a product assembly operation is analyzed to calculate a defective assembly potential of each part according to constituent elements of the operation.

Furthermore, as a method to extract an improvement measure of high abstraction degree from chaotic improvement examples in the past, there has been proposed, as described for example, in “Hassoho” (Jiro Kawakita, Chuo Koron Shinsha, 1967), a method in which similar examples are classified into groups and these groups are represented by abstracted upper-rank concepts.

However, only by reducing the material costs with the product structure kept unchanged, a remarkable product cost reduction effect has not been attained in many cases.

In addition, the part cost allocation method 1 described in “Value Engineering” (Yasuhiko Sato, Yurigu Inc., 1996) is based on (1) function achievement degree and (2) contribution degree, and has not an objective ground directly regarding the cost. Therefore, there does not exist a ground to set, as the improvement object, the cost summed up to a total for each function group. Additionally, since the improvement structure creation depends on the thinking of ideas, i.e., ability of individuals, an effective improvement structure proposal cannot be created and the process has come to a standstill in many cases.

Additionally, the two-element table in “Matrix 2003: Updating the TRIZ Contradiction Matrix” (Darrell Mann, Simon Dewulf, Boris Zlotin, Alla Zusman, CREAX Press, Belgium, 2003 is related to the basic performance and has not been applicable to the creation of member cost reduction structure.

Next, even if the assembly time of each constituent part is quantitatively evaluated to extract difficult assembly parts requiring a long assembly time, it is not possible to detect a method for improvement thereof, and hence the process has come to a standstill in many cases.

Furthermore, even if the defective assembly potential of each constituent part is quantitatively evaluated to extract parts having a high defective assembly potential, it is not possible to detect a method for improvement thereof, and hence the process has come to a standstill in many cases.

Also, in a situation wherein a plurality of improvement proposals for member cost reduction, a plurality of improvement proposals for assembly time reduction, and a plurality of improvement proposals for defective assembly reduction are created, there have appeared many cases wherein which ones of the improvement proposals are to be preferentially put to practices.

### SUMMARY OF THE INVENTION

It is an object of the present invention to provide a design support method and a design support system to solve the problem wherein parts, functions, attributes, assembly operations, and assembly attributes to be improved on the basis of objective grounds are quantitatively evaluated in a formularized procedure and guidelines for the improvement thereof are produced to thereby support creation of improvement structure to reduce the member costs, the assembly costs, and losses associated with defective assemblies.

To achieve the object according to the present invention, there is provided a design support system wherein in a design example as an improvement object, structure improvement guidelines are extracted to reduce the member costs, the assembly costs, and the losses associated with defective assemblies. For the processing in the design support system, there are beforehand saved, as databases, attributes, attribute values, and material•work method costs which can be realized using various materials and work methods; coefficients indicating assembly easiness of respective assembly operations and respective assembly attributes and coefficients indicating defective assembly potential, improvement guidelines of functions and attributes for the member cost reduction, improvement guidelines of assembly operations and attributes to reduce the assembly time, and improvement guidelines of assembly operations and attributes for the defective assembly reduction. From the constituent parts, functions, attributes, assembly operations, and assembly attributes of the design example, there are extracted elements having a high influence degree onto the member costs, the assembly costs, and the losses associated with the defective assemblies, to generate guidelines for the improvement thereof.

According to the present invention, by analyzing functions, attributes, and assembly operations and attributes of the constituent elements of the improvement object product, it is possible to produce a structure improvement guideline which reduces the member costs, the assembly time, and the defective assemblies.

Other objects, features and advantages of the invention will become apparent from the following description of the embodiments of the invention taken in conjunction with the accompanying drawings.

### BRIEF DESCRIPTION OF THE DRAWINGS

FIG. 1 is a general configuration diagram showing an embodiment of a design support system according to the present invention.

FIG. 2 is a diagram showing a processing flow of a design support system including creation of various databases and an embodiment of a configuration thereof according to the present invention.

FIG. 3 is a cross-sectional view showing a structure model as an example of a product design according to the present invention.

FIG. 4 is a part table of the structure model shown in FIG. 3.

FIG. 5 is a diagram showing a structural analysis table result of the structure model of FIG. 3.

FIG. 6 is a diagram showing results from member cost influence degree index calculations of structure elements of the structure model of FIG. 3.

FIG. 7 is a diagram showing extraction results of structure elements for which improvement of the structure model of FIG. 3 is required.

FIG. 8 is a diagram showing an example of a member cost improvement guideline configuring database according to the present invention.

FIG. 9 is a diagram showing an improvement guideline to reduce the member cost of the structure model of FIG. 3.

FIG. 10 is a diagram showing an improvement structure creation example of the structure model of FIG. 3.

FIG. 11A is a diagram showing an extraction example of adjacency of one part to another part in the structure model of FIG. 3.

FIG. 11B is a diagram showing an extraction example of attribute similarity of one part to another part in the structure model of FIG. 3.

FIG. 11C is a diagram showing an extraction example of the adjacency, the attribute similarity, and a reallocation effect index of one part to another part in the structure model of FIG. 3.

FIG. 12A is a diagram showing another extraction example of adjacency of one part to another part in the structure model of FIG. 3.

FIG. 12B is a diagram showing another extraction example of attribute similarity of one part to another part in the structure model of FIG. 3.

FIG. 12C is a diagram showing another extraction example of the adjacency, the attribute similarity, and a reallocation effect index of one part to another part in the structure model of FIG. 3.

FIG. 12D is a diagram showing an extraction example of a reallocation candidate part and a reallocation effect index of the structure model of FIG. 3.

FIG. 13 is a diagram showing an extraction example of a function reallocation guideline of the structure model of FIG. 3.

FIG. 14 is a diagram showing an example to extract replaceable members of the structure model of FIG. 3.

FIG. 15 is a diagram showing a design support processing flow in a second embodiment of a design support system according to the present invention.

FIG. 16 is a diagram showing an assembly operation of the structure model of FIG. 3.

FIG. 17 is a diagram showing an analysis result of an assembly operation in the structure model of FIG. 3.

FIG. 18 is a diagram showing a calculation result of a production cost influence degree index related to the assembly cost of assembly elements of the structure model of FIG. 3.

FIG. 19 is a diagram showing a calculation result of a production cost influence degree index related to the defective loss of assembly elements of the structure model of FIG. 3.

FIG. 20 is a diagram showing a result of addition between a production cost influence degree index related to the assembly cost of assembly elements and a production cost influence degree index related to the defective loss of assembly elements of the structure model of FIG. 3.

FIG. 21A is a diagram showing a result from improvement element extraction of structure elements of the structure model of FIG. 3.

FIG. 21B is a diagram showing a result from improvement element extraction of assembly elements of the structure model of FIG. 3.

FIG. 22 is a diagram showing an example of a total assembly cost improvement guideline configuring database in a second embodiment of a design support system according to the present invention.

FIG. 23 is a diagram showing a production cost reduction guideline of structure and assembly elements of the structure model of FIG. 3.

FIG. 24 is a diagram showing a creation example of production cost reduction structure of the structure model of FIG. 3.

FIG. 25 is a diagram showing an assembly operation of a production cost reduction structure creation example of the structure model of FIG. 3.

FIG. 26 is a flowchart of member cost influence degree index calculation processing and improvement element extraction processing.

FIG. 27 is flowchart 1 of function reallocation guideline generation processing.

FIG. 28 is flowchart 2 of function reallocation guideline generation processing.

### DESCRIPTION OF THE INVENTION

Description will be given in detail of embodiments according to the present invention.

### First Embodiment

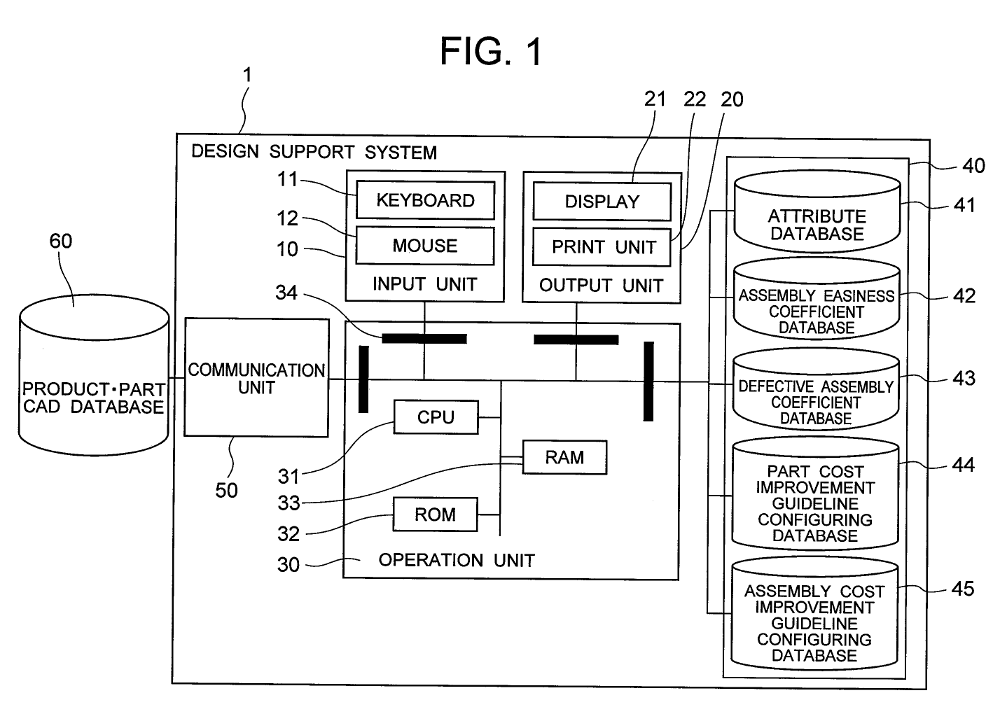

First, description will be given of a first embodiment of a design support system according to the present invention. FIG. 1 is a general configuration diagram showing an embodiment of a design support system according to the present invention. The design support system 1 according to the present invention includes input unit 10, output unit 20, operation unit 30, and a database unit 40. The input unit 10 includes a keyboard 11, a mouse 12, and the like. The output unit 20 includes a display 21, print unit 22, and the like. The operation unit 30 includes a CPU 31, an ROM 32, an RAM 33, and an input/output unit 34. Here, the operation unit 30 and the display 21 construct extraction and presentation unit.

Also, the database unit 40 includes an attribute database 41 and a member cost improvement guideline configuring database 44. In this regard, an assembly easiness coefficient database 42, a defective assembly coefficient database 43, and a total assembly cost improvement guideline configuring database 45 are used in a second embodiment. The present embodiment does not use them.

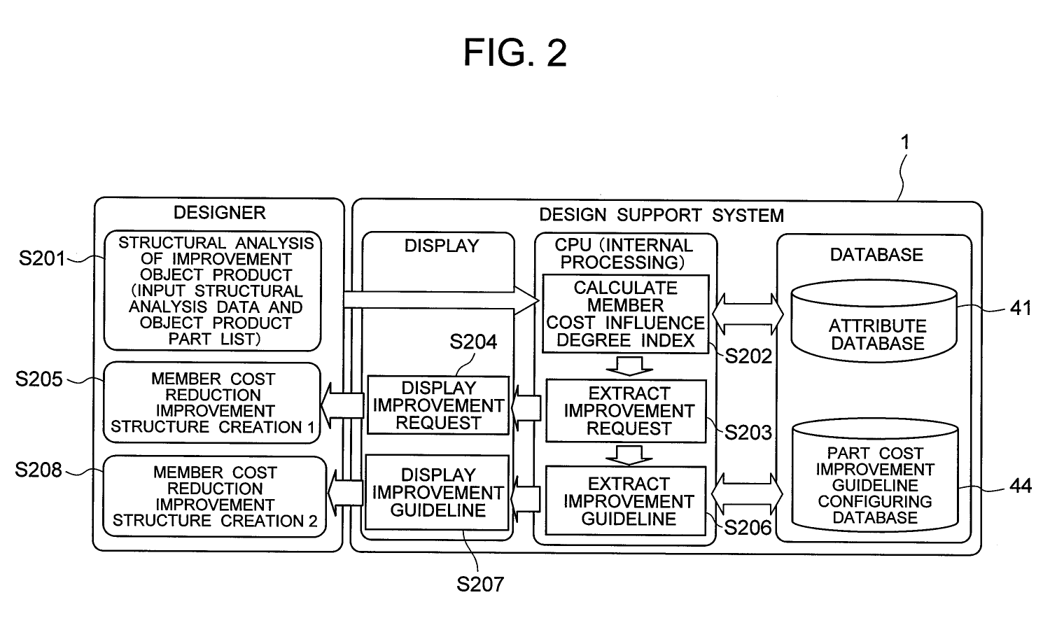

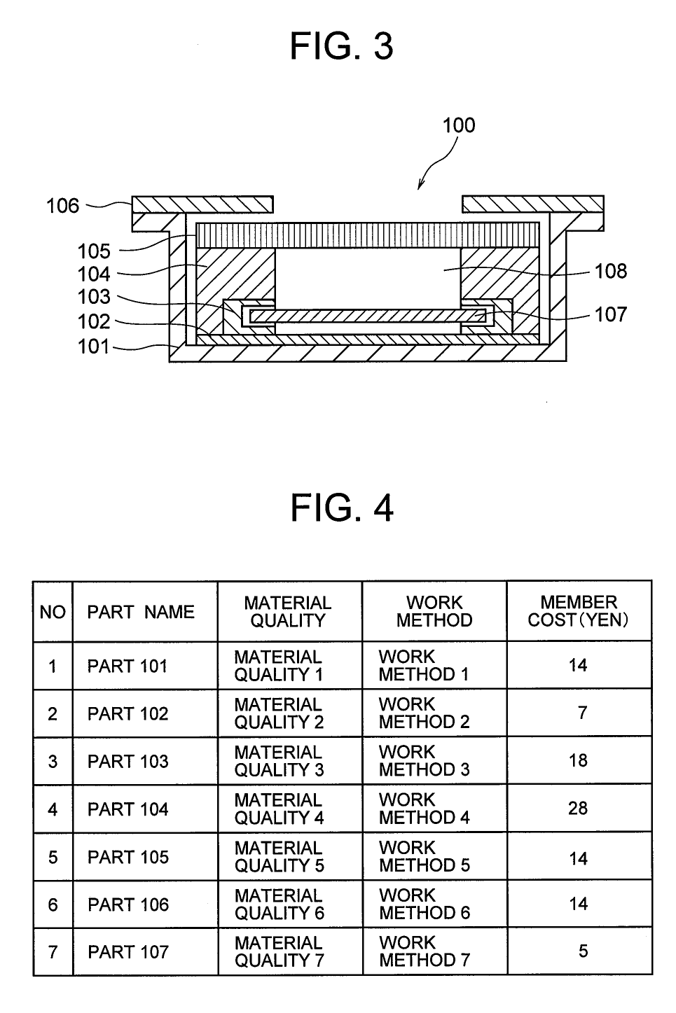

Next, description will be given of a first embodiment to achieve an improvement design to reduce the member cost in the design support system 1 according to the present invention. FIG. 2 is a diagram showing a first embodiment of a design support processing flow in the design support system 1. FIG. 3 is a structure model 100 as a design example of the present embodiment. FIG. 4 is a part table of the structure model 100.

### 1. Structural Analysis

In step S201 of FIG. 2, a designer analyzes the structure of an improvement object product and inputs, according to a design support interface provided by the design support system 1 to the designer, structural analysis data and the part table data of the improvement object product to the design support system 1. For the structural analysis data, the designer analyzes parts constituting the improvement object product, a function which each of the parts conducts for another part, and an attribute which each part possesses to make the function effective, and then inputs in a predetermined format all functions and all attributes which are assumed, by the designer, to be possessed by the respective parts. In the embodiment, the structure model 100 shown in FIG. 3 is set as the improvement object product. This is produced such that a part 102 is attached onto a part 101, a beforehand combined set of a part 103 and a part 107 is placed on the part 102, a part 104 is attached onto the part 107, a part 105 is further placed on the part 104, and a part 106 is attached onto the part 101.

As an example of the part table data to be inputted by the designer, FIG. 4 shows a part table of the structure model 100. The parts 101 to 107 inputted by the designer at a design evaluation point are produced through work methods 1 to 7 using respective materials 1 to 7. Also, the member cost which is a total of the material costs and the work costs of the respective parts is inputted to the part table.

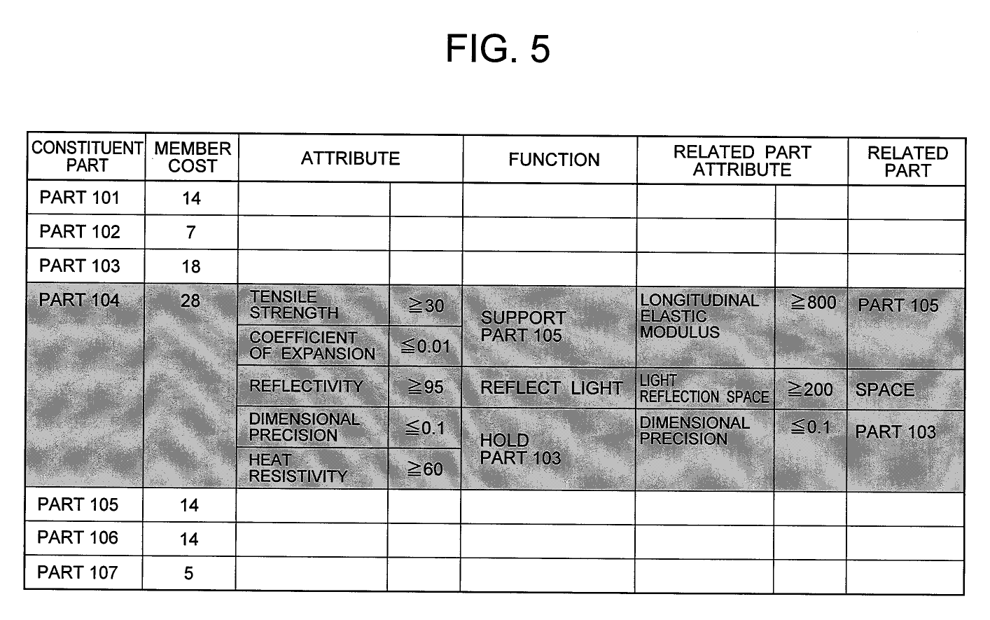

FIG. 5 shows the structural analysis data obtained by summarizing the structural analysis results. The structural analysis is carried out, for example, though the following procedure. In this connection, although the analysis may be conducted for all parts, an analysis example of the part 104 with the highest member cost will be described here.

(1) Post the constitutional parts and the member cost of the structure model 100.
(2) Extract all related parts to which the part 104 as the improvement object conducts a function. The parts 105 and 103 and the space 108 are extracted in this case.
(3) Extract functions which the part 104 conducts for the related parts. In this case, they are as follows.
[1] The part 104 supports a lower surface of the part 105.
[2] The part 104 reflects light into the space 108.
[3] The part 104 supports the part 103 on its side surface and its upper surface.
(4) To make the respective functions extracted in (3) effective, all attributes possessed by the part 104 are extracted. Further, ranges of the attribute values are described.

The above items are gathered and are inputted to the design support system 1 through the design support interface in the data table format shown in, for example, FIG. 5.

### 2. Member Cost Influence Degree Index Calculation

In step S202 of FIG. 2, by using the information of the structural analysis data and the part table data inputted by the designer in step S201 and the attribute database 41, the design support system 1 calculates, for each part constituting the improvement object product, each function which the part conducts for another part, and each attribute possessed by the part to make the function effective; a degree of influence thereof onto the total of the member costs of all parts constituting the improvement object product, the degree being an index with the total member cost set as 100.

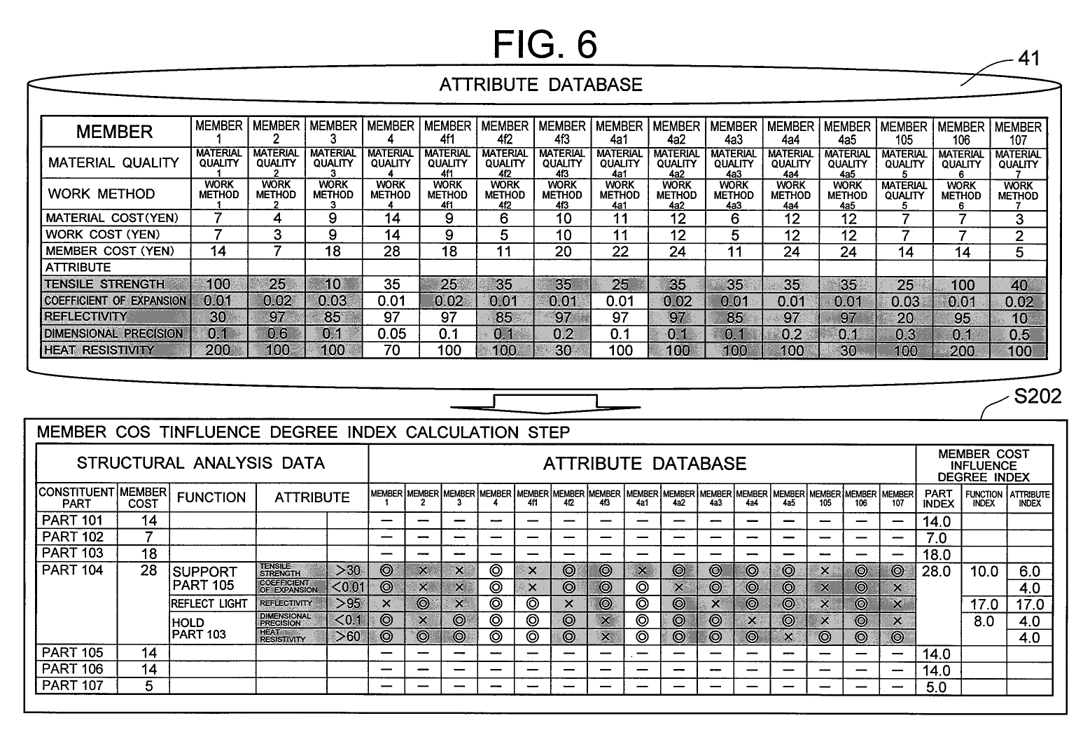

The database 41 shown in FIG. 6 is a database to which data items are registered in a data record format including a member, a member quality, a work method, a material cost, a work cost, a member cost, and various attributes. Each data record is uniquely identified by a combination of data of a material quality and data of a work method. Data of a member is equivalent to an ID to identify each data record and is used to retrieve a data record. For attributes shown as examples in FIG. 6, attribute values of only the attributes shown in the example of structural analysis data of FIG. 5 are shown for explanation. However, there are actually arranged items described in a material handbook and the like and various attribute items collected from the work technology textbooks and related technologies. There are also included attributes associated with “size” of the part and those associated with “weight” thereof.

Each data record is registered to the attribute database 41 as below. Using as a model, for example, an actually existing part or a part assumed for database registration, there is employed a data record candidate including a combination of material quality information of a material to manufacture the part and information of a work method to manufacture the part. If an existing data record equal in information to the combination has not been registered to the attribute database 41, the combination is registered as a new data record. In the registration processing, there is not registered the contour of the part as the model, but an attribute associated with “size” of the part and an attribute associated with “weight” thereof are registered. Additionally, for the values of other attributes of the part, only attribute data of each attribute of which the value is known is registered. Furthermore, on the basis of the unit price of the material of the registered part and the attributes associated with “size” and “weight” of the part, the material cost is calculated to be registered to the material cost field. Also, on the basis of the unit price of the work method of the registered part and the attributes associated with “size” and “weight” of the part, the work cost is calculated to be registered to the work cost field. The member cost is obtained by adding the material cost to the work cost to be registered to the member cost field. Finally, a unique name is registered as the member name to the member field. As described above, although the new record thus registered is based on a model of the part, there is not registered data unique to the part, but the contour of the part is abstracted to register attributes associated with “size” and “weight”. The combination of the material information and the work method information is used to register a unique, new data record. Hence, if the combination of the material information and the work method information is equal to information of an existing data record, the registration processing is not executed. Through the registration processing, the attribute database 41 is created in advance. In addition, it is updated according to necessity.

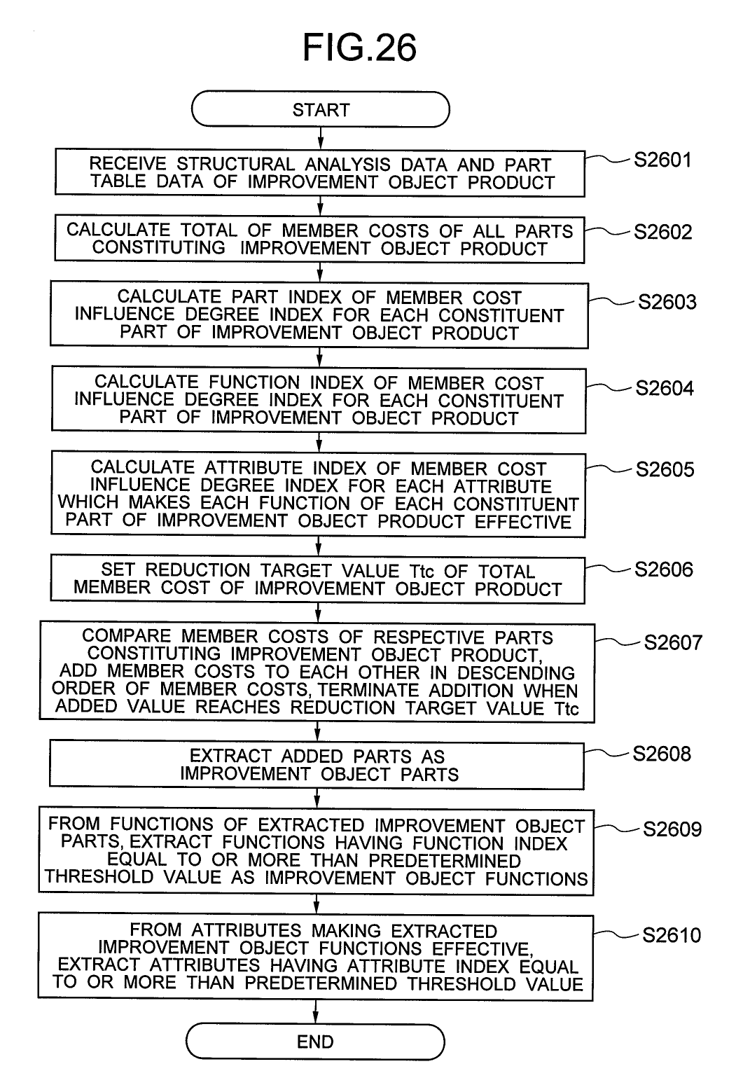

Next, description will be given of a calculation procedure of the member cost influence degree index. FIG. 26 shows the procedure in a flowchart.

(1) The total of member costs of all parts constituting the improvement object product is calculated (step S2602).
(2) The difference in the total member cost due to presence or absence of one improvement object product can be regarded as an amount due to presence of the part. Therefore, a value obtained by multiplying by 100 a value attained by dividing the difference in the total member cost by the total member cost is defined as a part index of the member cost influence degree index. For example, the part index of part 104 is represented by the following expression.

(28/100)×100=28 (Expression 1)

(3) The difference in the member cost due to presence or absence of any attribute making a particular function of an improvement object product effective can be regarded as an amount due to presence of the function. Therefore, a value obtained by multiplying by 100 a value attained by dividing the difference in the member cost by the total member cost is defined as a function index of the member cost influence degree index. For example, for the “support part 105” function of the part 104, there is extracted from the attribute database 41 a combination of data record material quality and work method including data of a material quality and data of a work method, the combination not satisfying attributes “tensile strength” and “ratio of thermal expansion” of the part 104 making the function “support part 105” effective, but satisfying the other attributes of the part 104. If there exist a plurality of data records of pertinent combinations of data of a material quality and data of a work method, a member of the lowest price is selected. From the example of the attribute database 41 of FIG. 6, a member 4f₁ is selected as the pertinent member. The function index of the “support part 105” function of the part 104 is represented by the following expression.

((28−18)/100)×100=10 (Expression 2)

(4) The difference in the member cost due to presence or absence of a particular attribute making a function of an improvement object product effective can be regarded as an amount due to presence of the attribute. Therefore, a value obtained by multiplying by 100 a value attained by dividing the difference in the member cost by the total member cost is defined as an attribute index of the member cost influence degree index. For example, for the attribute “tensile strength” making the “support part 105” function of the part 104 effective, there is extracted from the attribute database a combination of data record material quality and work method including data of a material quality and data of a work method which does not satisfy the attribute “tensile strength” of the part 104 and which satisfies the other attributes of the part 104. If there exist a plurality of data records of pertinent combinations of data of a material quality and data of a work method, a member of the lowest price is selected. In this situation, a member 4a₁ is selected as the pertinent member. The attribute index of the attribute “tensile strength” making the function “support part 105” of the part 104 effective is represented by the following expression.

((28−22)/100)×100=6 (Expression 3)

Subsequently, the member cost influence degree index is similarly calculated for all structure elements (parts, functions, attributes) of the inputted structural analysis data (steps S2603 to S2605).

### 3. Improvement Element Extraction

In step S203 of FIG. 2, the design support system 1 extracts structure elements requiring improvement on the basis of the member cost influence degree indices calculated in step S202. The procedure will be described.

(1) The system 1 reads the target value, which is set and inputted by the designer in advance, of the total member cost to reduce the member cost of the improvement object product and then sets the value as a threshold value T_{tc} of the following processing (step S2606).
(2) The system 1 adds the member costs of the respective parts constituting the improvement object product to each other in a descending order of the member costs until the result of the addition reaches the threshold value T_{tc} set in (1), and terminates the addition when value T_{tc} is reached (step 2607); and then extracts all parts associated with the operation as part candidates requiring improvement (step S2608).
(3) From the functions to be conducted by the parts extracted in (2), the system 1 extracts, as functions requiring improvement, functions of which the function index exceeds a beforehand set threshold value T_{fi} (step S2609).
(4) From the attributes which make the functions extracted in (3) effective, the system 1 extracts, as attributes requiring improvement, any attribute whose attribute value exceeds a beforehand set threshold value Tₚᵢ (step S2610).

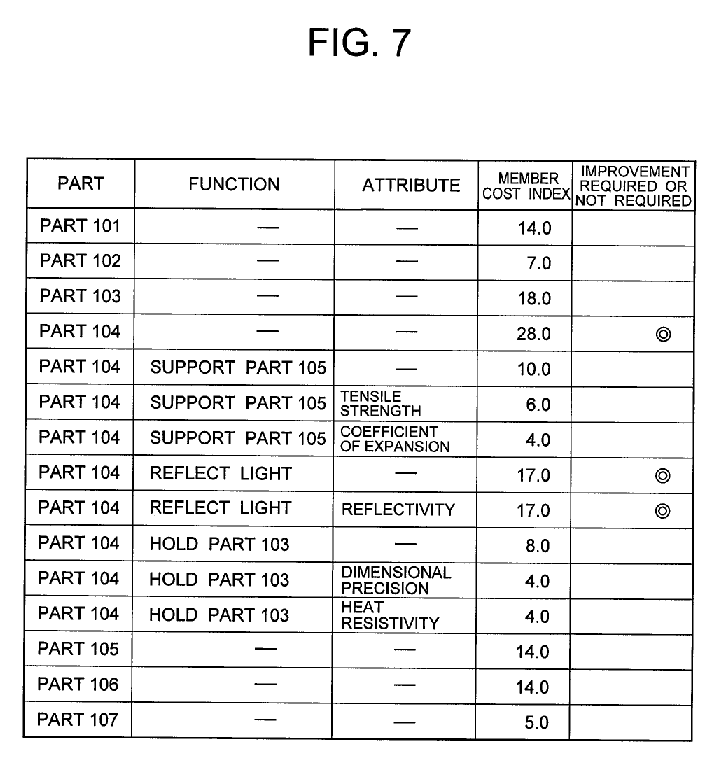

In the present embodiment, there are extracted the part 104 as the part requiring improvement, “reflect light” as a function requiring improvement, and “reflectivity” as an attribute requiring improvement. The results are indicating by a double circle in FIG. 7.

If it is desired to extract only structure elements (parts, functions, attributes) requiring improvement, the design support system 1 displays in step S204 of FIG. 2 the structure elements which require improvement and which are extracted in step S203 as shown in FIG. 7. In step S205 of FIG. 2, the designer can efficiently detect structure elements requiring improvement for the member cost reduction by referring to the results in FIG. 7, and it is hence possible to reduce the design time.

If it is desired to extract an improvement guideline, control goes from step S203 to step S206 without conducting steps S204 and S205 of FIG. 2.

### 4. Improvement Guideline Creation

In step S206 of FIG. 2, the design support system 1 creates an improvement guideline for the structure element requiring improvement extracted in step S203, according to input data from the designer and the member cost improvement guideline configuring database 44.

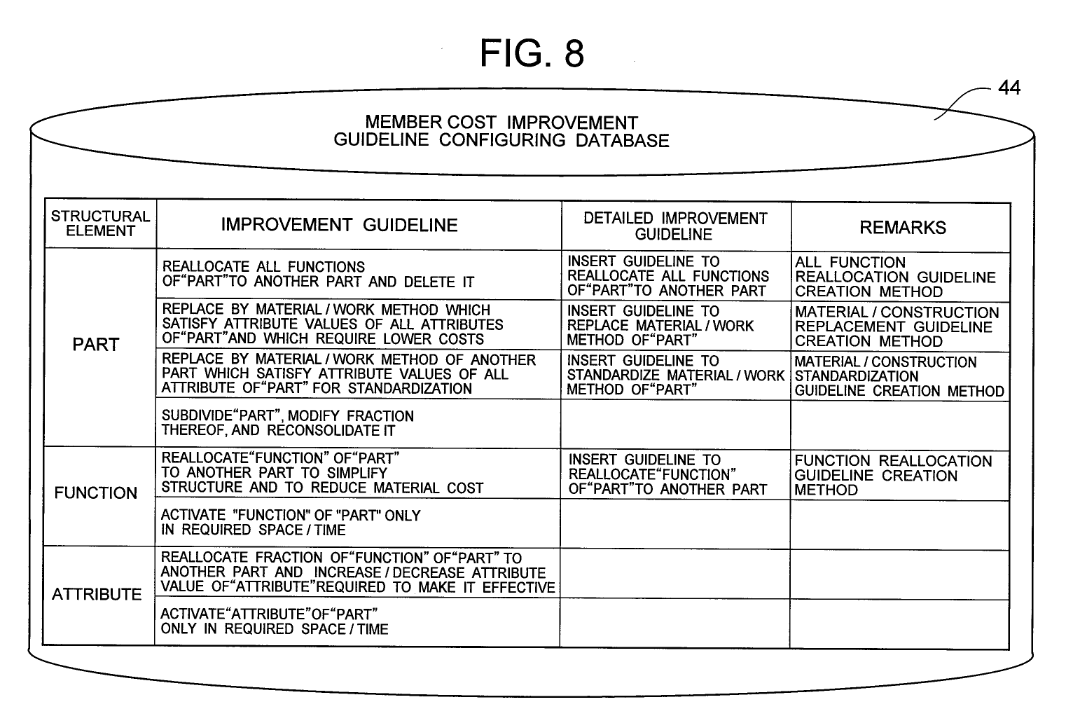

First, description will be give of the guideline configuring database 44. As FIG. 8 shows, the database 44 establishes a correspondence between improvement guidelines obtained by abstracting various improvement examples in the past and the structure elements as improvement objects. Also, it is implied to create “detailed improvement guideline” related to an improvement guideline using following methods. Details of each method will be described later. (1) Function reallocation guideline creation method, (2) all function reallocation guideline creation method, (3) material quality/work method replacement guideline creation method, and (4) material quality/work method standardization guideline creation method.

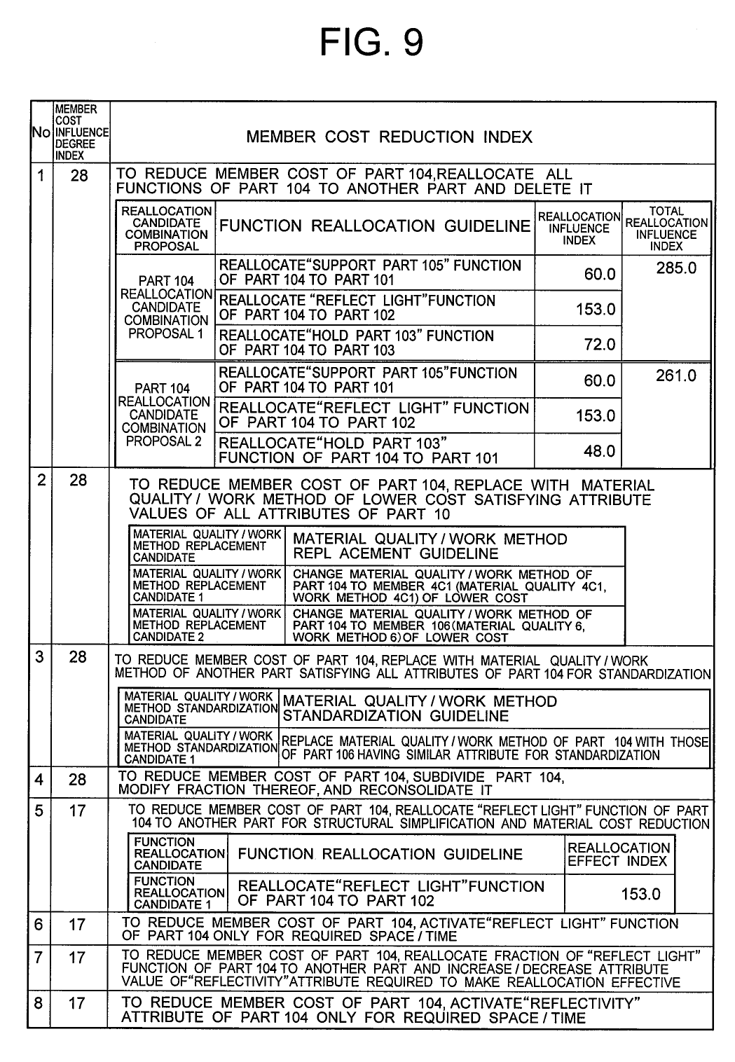

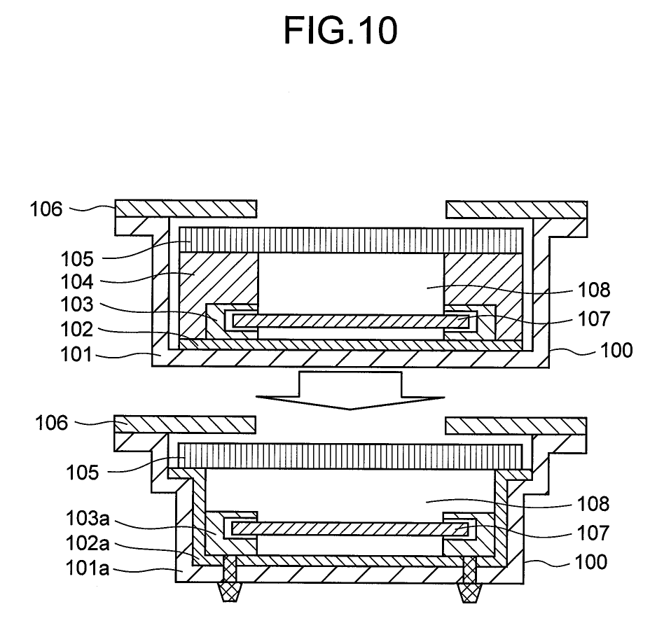

The design support system 1 creates, as FIG. 9 shows, an improvement guideline for the structure elements requiring improvement extracted in step S203. Additionally, FIG. 10 shows an improvement structure example created by the designer on the basis of the created improvement guideline. Next, description will be given of the contents of FIG. 9.

First, description will be given of No. 1 “To reduce member cost of part 104, reallocate all functions of part 104 to another part and delete it”. First, the improvement target is clarified. In this situation, there is set an improvement guideline including a combination of “part 104” as the improvement object part and “to reduce member cost” as the improvement target. From the member cost improvement guideline configuring database 44, “reallocate all functions of “part” to another part and delete it” as the part improvement guideline is extracted and is then combined with “part 104” as the improvement object part.

However, since the improvement guideline is an abstract expression, there is created a detailed improvement guideline to reallocate all functions to another part, and the guideline is inserted in a table. The improvement guideline to reallocate all functions to another part is generated through two stages as follows.

(1) An improvement guideline to reallocate all functions to another part is created (function reallocation guideline creation method).
(2) All functions to be conducted by the part to another part are reallocated (all function reallocation guideline creation method).

Next, description will be given of each method.

### 4.1 Function Reallocation Guideline Creation Method

As shown in the structure analysis data of FIG. 5, each part constituting a product has a function to act upon another part. By reallocating the function to another part, it is possible to simplify structure and to reduce the material cost. For this purpose, using a formularized method, there is extracted another part suitable for the reallocation of the function.

Another part suitable for the reallocation of the function must have two necessary conditions as below.

(1) Adjacency: Adjacent to the improvement object part.
(2) Attribute similarity: Possessing an attribute similar to an attribute required to make the function of improvement object part effective.

Moreover, a function having a larger improvement effect through the function reallocation is a function having a larger function index of the member cost influence degree index. In this situation, an index (reallocation effect index) indicating the magnitude of the function reallocation effect is defined by the following expression (Expression 4).

[reallocation effect index]=[adjacency]×[attribute similarity]×[function index of member cost influence degree index] (Expression 4)

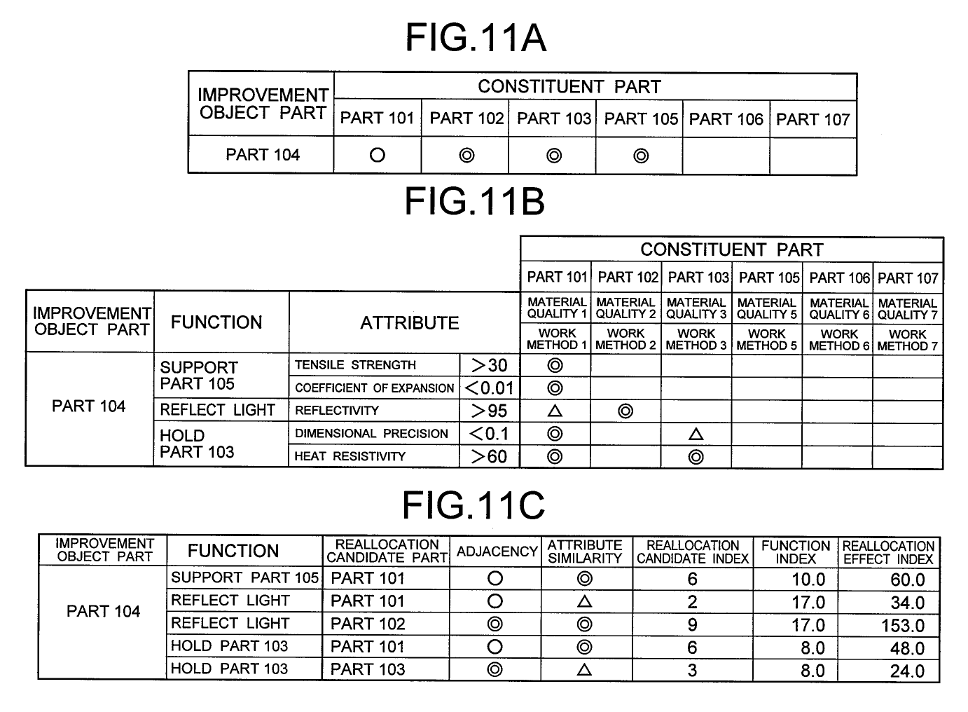

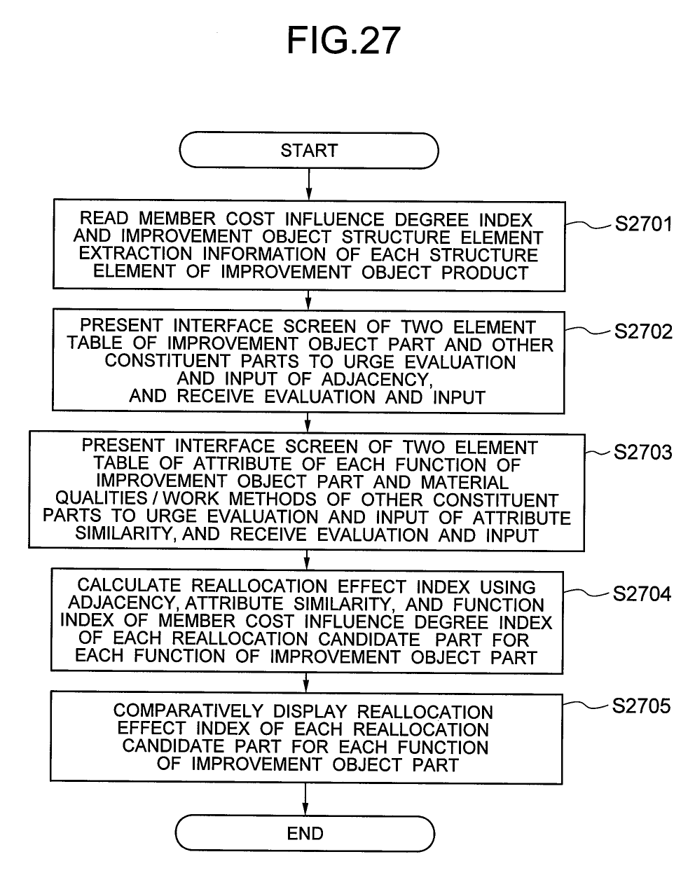

Screen display examples shown in FIGS. 11A to 11C show processing in which the design support system 1 presents an interface screen to urge the designer to evaluate [adjacency] and [attribute similarity], the designer evaluates an inputs data in response thereto, and then the system 1 calculates [reallocation effect index] according to the input data (shown in a flowchart of FIG. 27).

(1) First, as FIG. 11A shows, the system 1 creates and displays a two-element table including the part 104 as the improvement object part and the other parts constituting the product. The designer evaluates adjacency between the part 104 and the other parts through the following three stages and inputs data (step S2702). Examples of symbols to be inputted are as follows.
[1] ⊚: Directly in contact with.
[2] ◯: Adjacent to. [3] Δ: Capable of being adjacent to (assumed that the parts may be adjacent to each other through a design change).
(2) Next, as FIG. 11B shows, the system 1 creates and displays a two-element table including input data (structural analysis data) regarding the part 104 and material quality/work method of each of the other parts. The designer evaluates similarity between an attribute of the part 104 and that of each of the other parts through the following three stages and inputs data (step S2703). Examples of symbols to be inputted are as follows.

[1] ⊚: Equivalent attribute. [2] ◯: Similar attribute. [3] Δ: Capable of assigning similar attribute (assumed that a similar attribute is assignable through a design change).

(3) Using the evaluation data evaluated and inputted by the designer, for each function of the part 101, the design support system 1 calculates, for a reallocation candidate part for which the symbol has been assigned to adjacency and attribute similarity, a reallocation candidate index as a product between the adjacency and the attribute similarity as shown in FIG. 11C. In the calculation, it is assumed that a ⊚ is three, a ◯ is two, and a Δ is one.

Furthermore, the system 1 calculates a reallocation effect index by multiplying the reallocation candidate index by the member cost influence degree index (step S2704).

Through the processing above, there is obtained in this example a guideline indicating that the improvement to reallocate “reflect light” function of the part 104 to the part 102 leads to the largest member cost reduction effect.

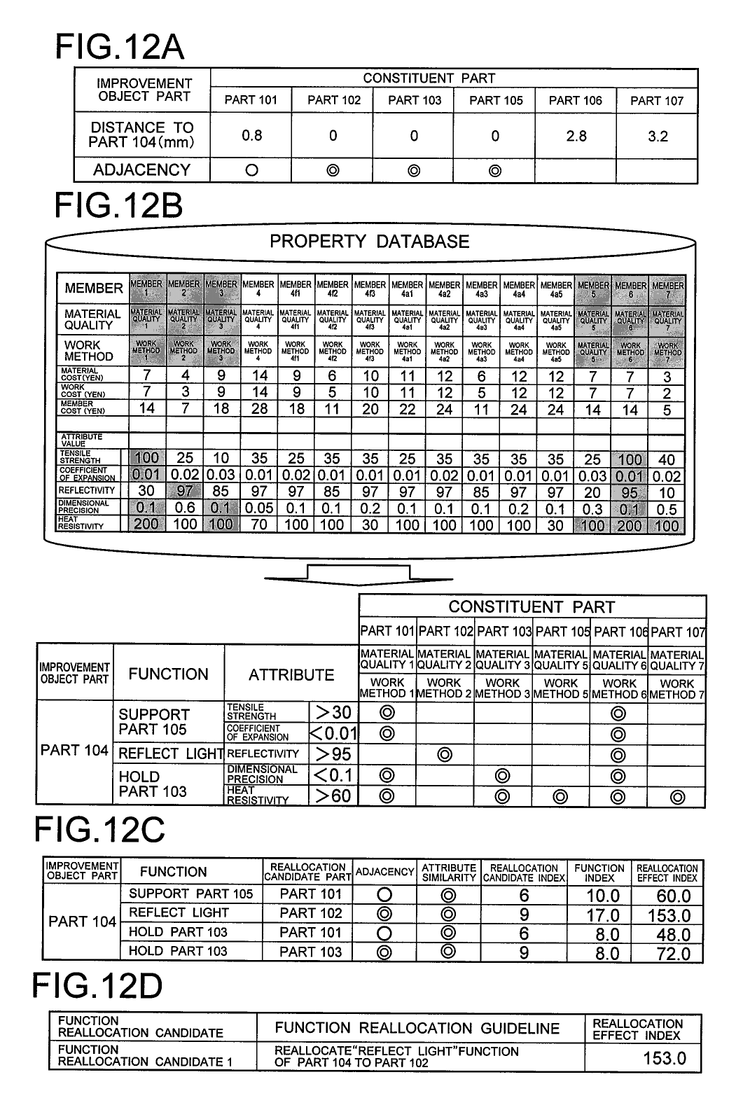

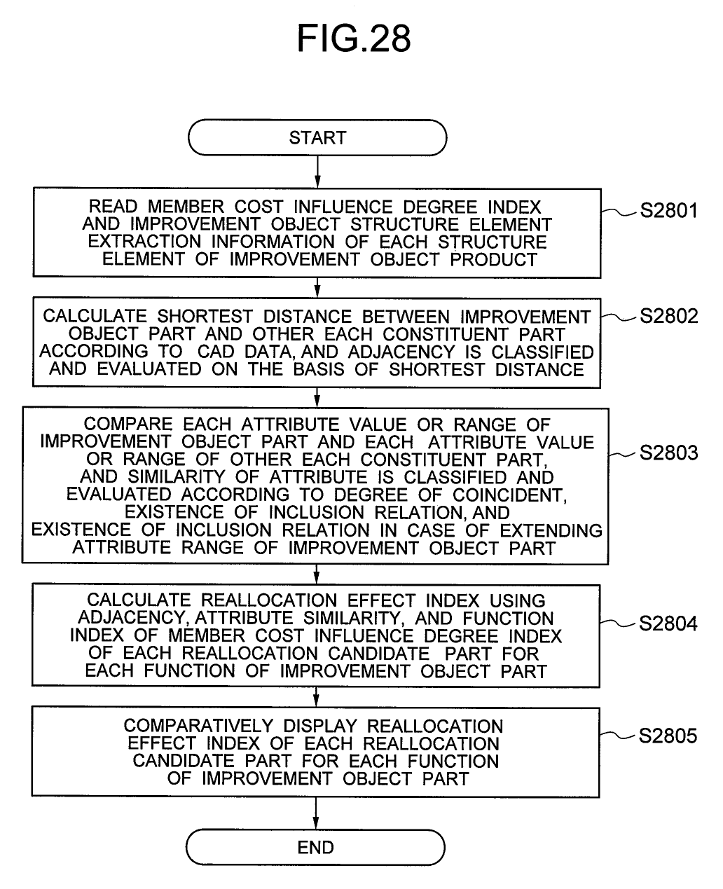

Description will be given of another processing example in which the design support system 1 calculates “reallocation effect index”. FIG. 28 shows a flowchart of the processing example. The system 1 receives a designation of an improvement object product via the input unit from the designer and receives the structural analysis data, and the part table data, and CAD data of the product and parts according to necessity via the input unit 10 or communication unit 50 from a product-part CAD database 60 (step S2801). As FIGS. 12A to 12D show, the design support system 1 evaluates [adjacency] and [attribute similarity] and calculates [reallocation effect index].

(1) First, as FIG. 12A shows, the system 1 calculates the shortest distance between the improvement object part and the other parts according to the CAD data of the improvement object part and constituent parts thereof. Adjacency is evaluated on the basis of the distance X (step S2802). The contents of respective symbols are defined, for example, as follows.

### [1] ⊚: X=0. [2] ◯: 0<X≦1.0. [3] Δ: 1.0<X≦2.0.

(2) Next, the system 1 creates, as FIG. 12B shows, a two-element table (data table) of input data regarding the part 104 (attribute data of the structural analysis data) and material quality/work method of each of the other parts of the constituent parts. The system 1 extracts the other parts possessing an attribute value satisfying an attribute value range of the part 104 from the part table and the attribute database 41. Although an attribute value of each data record identified by each material quality/work method combination stored in the database 41 shown in FIG. 12B is indicated by one value, the attribute value need not be necessarily indicated by one value, but a range of the attribute value may also be registered. That an attribute value or an attribute value range of one member stored in the database 41 satisfies the attribute value range possessed by the part 104 unit that the attribute value or the attribute value range of the member is completely included in the attribute value range of the part 104.

In the example, the design support system evaluates similarity between an attribute of the improvement object part and that of the other constituent parts through the following three stages (step S2803).

[1] ⊚: An attribute value or an attribute value range of another constituent part is included in the attribute range of the improvement object part. [2] ◯: If the attribute value range is extended to 90% of the lower-limit value of the attribute value of the improvement object part or if the upper-limit value of the attribute value or the attribute value range is changed to 90% thereof, it is included in the attribute range of the improvement object part. [3] Δ: If the attribute value range is extended to 80% of the lower-limit value of the attribute value of the improvement object part or if the upper-limit value of the attribute value or the attribute value range is changed to 80% thereof, it is included in the attribute range of the improvement object part.

(3) Next, as FIG. 12C shows, for each function of the part 104 and for the reallocation candidate part to which a symbol is assigned with respect to the adjacency and the attribute similarity, the system calculates a reallocation candidate index as a product between the adjacency and the attribute similarity. In the processing, the evaluation values are as follows: ⊚=three, ◯=2, Δ=1.

In addition, the system calculates a reallocation effect index by multiplying the reallocation candidate index by a function index of the member cost influence degree index (step S2804).

(4) Finally, as FIG. 12D shows, in step S103 of FIG. 2, the design support system 1 selects, as structure elements requiring improvement, a function and a reallocation candidate part for the largest reallocation effect index, and outputs reallocation guideline information of the selected “reflect light” function. Or, the system 1 comparatively outputs all reallocation candidate parts and the reallocation effect indices (step S2805).

### 4.2 All Function Reallocation Guideline Creation Method

This is processing in which all functions to be achieved by the part are reallocated to other parts to thereby create an improvement guideline which deletes the part. The procedure of the processing is as below.

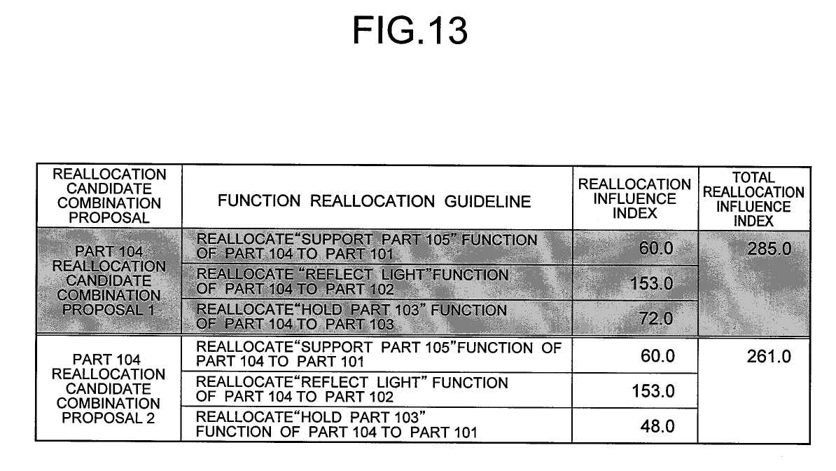

(1) First, as in a procedure similar to 4.1, reallocation candidate parts are selected for all functions of the improvement object part, and reallocation effect indices are calculated to create function reallocation guideline candidates for each function.
(2) Next, for all combinations resultant from a selection of one guideline for each function, a total of reallocation effect indices is calculated.
(3) Finally, as FIG. 13 shows, the design support system 1 presents in step S203 of FIG. 2 a list of reallocation candidate combination proposals of “part 104” extracted as a structure element requiring improvement in a descending order of the total reallocation effect index.

Next, description will be given of No. 2 of FIG. 9 “To reduce member cost of part 104, replace with material/work method of lower cost satisfying attribute values of all attributes of part 104”. From the member cost improvement guideline configuring database 44, a part improvement guideline “replace with material/work method of lower cost satisfying attribute values of all attributes of “part”” is extracted and is combined with the improvement object part “part 104”.

However, since the improvement guideline is an abstract expression, there is created a detailed improvement guideline to replace with “material quality/work method of lower cost satisfying attribute values of all attributes and it is inserted in a table (a material quality/work method replacement guideline creation method).

The system extracts material qualities/work methods of a lower cost satisfying attribute values of all attributes possessed by the part to produce material quality/work method replacement guidelines. The procedure of the processing is as follows.

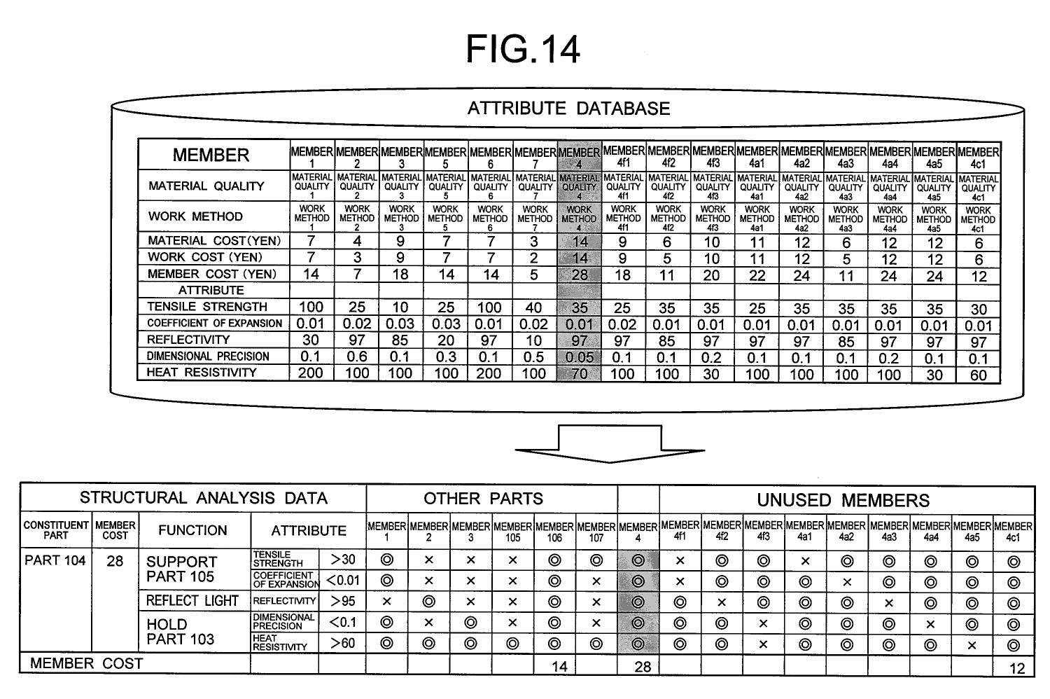

(1) First, as FIG. 14 shows, the system extracts items for which the attribute values of the data records identified by a material quality/work method combination stored in the attribute database 41 completely satisfy the attribute ranges of the attributes possessed by the part 104. In this example, the members 4c₁ and 6 are extracted.
(2) From the members, the system extracts a member whose member cost is less than that of the part 104.
(3) The system configures an improvement guideline including replacement parts using these members and presents a list thereof in a descending order of the effect.

Subsequently, description will be given of No. 3 of FIG. 9 “To reduce member cost of part 104, replace with material quality/work method of another part satisfying attribute values of all attributes of part 104 for standardization of material quality/work method”. In production of a part which cannot be deleted, if a plurality of parts can be produced using the same material quality and the same work method, it is possible to reduce the material cost and the work cost. In this case, the method of reducing the member cost by equalizing the material quality/work method is referred to as standardization of material quality/work method. From the member cost improvement guideline configuring database 44, the system extracts the part improvement guideline “replace with material quality/work method of another part satisfying attribute values of all attributes of “part”” and combines the guideline with “part 104” as the improvement object part.

However, since the improvement guideline is an abstract expression, there is created a detailed improvement guideline to replace with “material quality/work method of another part satisfying attribute values of all attributes” and it is inserted in a table (a material quality/work method standardization guideline creation method).

Description will be given of a procedure to extract another part possessing attributes satisfying the attribute ranges of all attributes of the improvement object part to thereby create a material quality/work method standardization guideline.

(1) First, the system reads material quality/work method data of another constituent part from the part table (FIG. 4) and then extracts, as FIG. 14 shows, members for each of which the attribute value of the data record possessing the material quality/work method of the part stored in the attribute database completely satisfies the attribute ranges of all attributes of the improvement object part 104.
(2) From the extracted members, the system extracts members having a member cost equal to or less than that of the part 104.
(3) The system creates improvement guidelines to recommend improvement to a standardized part including these members and presents them in a descending order of the higher member cost improvement.

Next, description will be given of No. 4 of FIG. 9 “To reduce member cost of part 104, subdivide part 104, modify fraction thereof, and reconsolidate it”. From the member cost improvement guideline configuring database 44, the system extracts the part improvement guideline “subdivide “part”, modify fraction thereof, and reconsolidate it” and combines the guideline with “part 104” as the improvement object part.

This guideline is obtained by abstracting structure of, for example, a resin chassis of a family-use electric appliance or the like for which high heat insulation is required. In this situation, there is not employed structure in which the chassis is of two-layer structure and a heat isolator is sandwiched therebetween, but the chassis is subdivided into three elements of an outer element, a central element, and an inner element such that the central part is foamed to increase the heat isolation effect and the outer and inner elements are ordinary resin films, the elements being formed into one block.

Subsequently, description will be given of No. 5 of FIG. 9 “To reduce member cost of part 104, reallocate “reflect light” function of part 104 to another part for structural simplification and material cost reduction”. From the member cost improvement guideline configuring database 44, the system extracts the part improvement guideline “reallocate function of “part” to another part for structural simplification and material cost reduction” and combines the guideline with “part 104” and “reflect light” as the improvement object structure elements.

However, since the improvement guideline is an abstract expression, there is created a detailed improvement guideline to reallocate the function to another part and it is inserted in a table. The creation of the improvement guideline to reallocate the function to another part is conducted using the function reallocation guideline creation method described above.

Next, description will be given of No. 6 of FIG. 9 “To reduce member cost of part 104, activate “reflect light” function of part 104 only for required space/time”. From the guideline configuring database 44, the system extracts the part improvement guideline “activate “function” of “part” only for required space/time” and combines the guideline with “part 104” and “reflect light” as the improvement object structure elements.

This guideline is obtained by abstracting structure of, for example, a resin chassis of a family-use electric appliance or the like in which high reflectivity of light is required for a particular section of its inner side. In this situation, there is not employed structure in which the chassis is entirely formed using a resin having high resistivity, but only the section requiring high resistivity is formed to posses a mirror surface.

Subsequently, description will be given of No. 7 of FIG. 9 “To reduce member cost of part 104, reallocate fraction of “reflect light” function of part 104 to another part and increase/decrease attribute value of “reflectivity” attribute required to make reallocation effective”. From the member cost improvement guideline configuring database 44, the system extracts the part improvement guideline “reallocate fraction of “function” of “part” to another part and increase/decrease attribute value of “attribute” required to make reallocation effective” and combines the guideline with “part 104”, “reflect light”, and “reflectivity” as the improvement object structure elements. Although this is implemented by assuming the reallocation of “function”, the member cost remarkably varies by removing or by increasing/decreasing important attributes in association with the function reallocation in some cases.

Next, description will be given of No. 8 of FIG. 9 “To reduce member cost of part 104, activate “reflectivity” attribute of part 104 only for required space/time”. From the guideline configuring database 44, the system extracts the part improvement guideline “activate “attribute” of “part” only for required space/time” and combines the guideline with “part 104” and “reflectivity” as the improvement object structure elements.

In step S207 of FIG. 2, the design support system 1 displays the improvement guidelines created in step S206 on a display. In step S208 of FIG. 2, the designer can efficiently create improvement structure by referring to the improvement guidelines on the display.

FIG. 10 shows an improvement structure creation example. This is a structure creation example in which three functions to be achieved by the part 104 are reallocated to another part.

(1) The “support part 105” function of the part 104 is designated in structure in which on the basis of improvement guideline no. 1, combination proposal 1 “reallocate “support part 105” function of part 104 to part 101”, “dispose crank-shaped receiving section to support part 105 on upper section of part 101 to support part 105 by the receiving section”.
(2) The “reflect light” function of the part 104 is designated in structure in which on the basis of improvement guideline no. 1, combination proposal 1 “reallocate “reflect light” function of part 104 to part 102”, “extend both ends of part 102 and bend both sides to reflect light on both side surfaces”.
(3) The “support part 103” function of the part 104 is designated in structure in which on the basis of improvement guideline no. 1, combination proposal 1 “reallocate “support part 103” function of part 104 to part 103”, “dispose projection to engage with part 101 on lower section of part 103 to hold part 103 itself by the projection”.

As above, according to the present invention, there can be attained improvement guidelines of structure elements having a high member cost reduction effect only by inputting structural analysis data, and it is hence possible to improve efficiency of the member cost reduction design.

### Second Embodiment

First, description will be given of a second embodiment of a design support system according to the present invention. FIG. 1 is a general configuration diagram showing an embodiment of a design support system according to the present invention. The design support system 1 according to the present invention includes input unit 10, output unit 20, operation unit 30, and a database unit 40. The input unit 10 includes a keyboard 11, a mouse 12, and the like. The output unit 20 includes a display 21, print unit 22, and the like. The operation unit 30 includes a CPU 31, an ROM 32, an RAM 33, and an input and output unit 34. Here, the operation unit 30 and the display 21 construct extraction and presentation unit.

Also, the database unit 40 includes an attribute database 41, an assembly easiness coefficient database 42, a defective assembly coefficient database 43, a member cost improvement guideline configuring database 44, and a total assembly cost improvement guideline configuring database 45.

Next, description will be given of a second embodiment which conducts an improvement design to reduce the production cost obtained by adding to each other the member costs of purchased parts, the assembly costs due to assembly work, and losses associated with defective assemblies (to be abbreviated as a defective loss hereinbelow) in the design support system 1 according to the present invention.

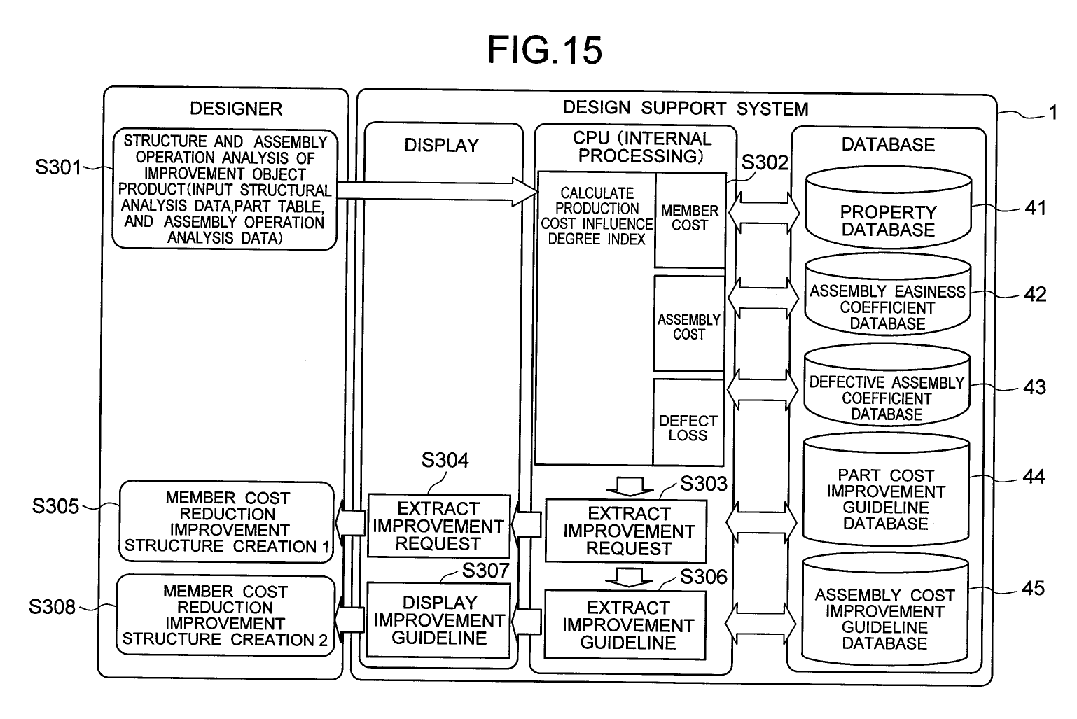

FIG. 15 is a diagram showing a design support processing flow in the second embodiment of the design support system. FIG. 3 is a structure model 100 as a design example of the present embodiment. FIG. 4 is a part table of the structure model 100. FIG. 5 is structural analysis data of the structure model 100.

### 1. Structural and Assembly Operation Analysis

In step S301 of FIG. 15, the designer analyzes the structure and the assembly operation of the improvement object product and inputs analysis results to the design support system 1. In this case, the structure model 100 shown in FIG. 3 is assumed as the structure model 100. FIG. 4 shows the part table thereof.

### 1.1 Structural Analysis

The designer analyzes parts constituting the improvement object product, functions which these parts conducts for other parts, and attributes of the respective parts to make these functions effective. This is equal to the structural analysis described in conjunction with the first embodiment. FIG. 5 shows results of the structural analysis. In this regard, parts, functions, and attributes are collectively called structure elements. After the structural analysis, the designer inputs structural analysis data and part table data of the improvement object product to the design support system 1 (S301).

### 1.2 Assembly Operation Analysis

The designer analyzes parts constituting the improvement object product, assembly operations of these parts, and assembly attributes as evaluation items affecting easiness of assembly operations. For the assembly operations, there are beforehand designated the operational contents of part assembly operations such as “downward movement”, “horizontal movement”, “upward movement”, “shape”, and “hold” to select therefrom an associated assembly operation. The “downward movement” of the assembly operation is assumed as a reference assembly operation. Also, for assembly attributes, there are beforehand defined various attributes such as “flexible”, “simultaneous engagement”, “with designed surface”, and “difficult to view engage section”. An associated assembly attribute is selected therefrom.

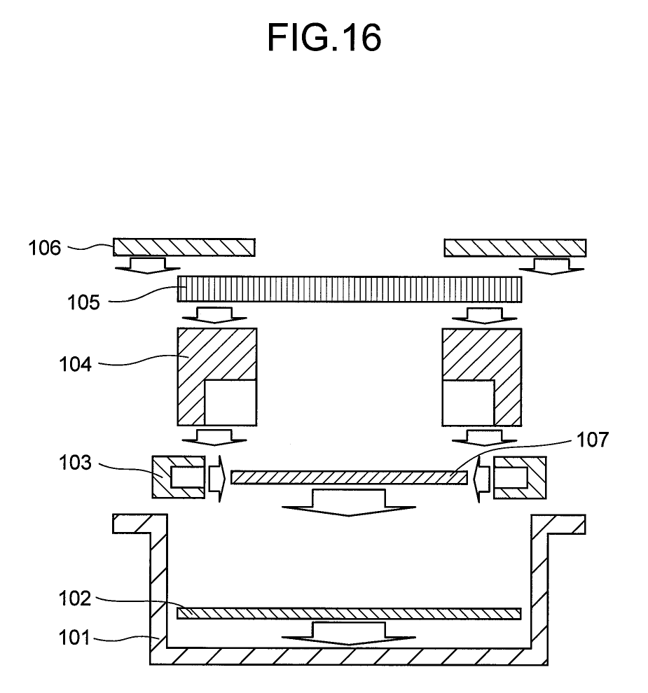

FIG. 16 shows a general diagram of the assembly operation of the structure model 100. The assembly operation is subdivided into assembly elements (parts, assembly operations, and assembly attributes) for the analysis.

(1) Move part 101 downward.
(2) Move part 102 downward and place it on part 101.
(3) Move part 107 downward up to intermediate point and hold. Shape and position part 103 and move it horizontally to insert in part 107. In the operation, part 103 simultaneously engages with part 107. Additionally, part 107 is fragile and is hence to be carefully handled. A set of parts 107 and 103 is shaped to be positioned and is downward moved to be placed on part 102. Thereafter, the set of parts 107 and 103 is held until the next part 104 is completely assembled.
(4) Move part 104 downward and place it on part 102.
(5) Move part 105 downward and place it on part 104.
(6) Move part 106 downward and attach it onto part 101.

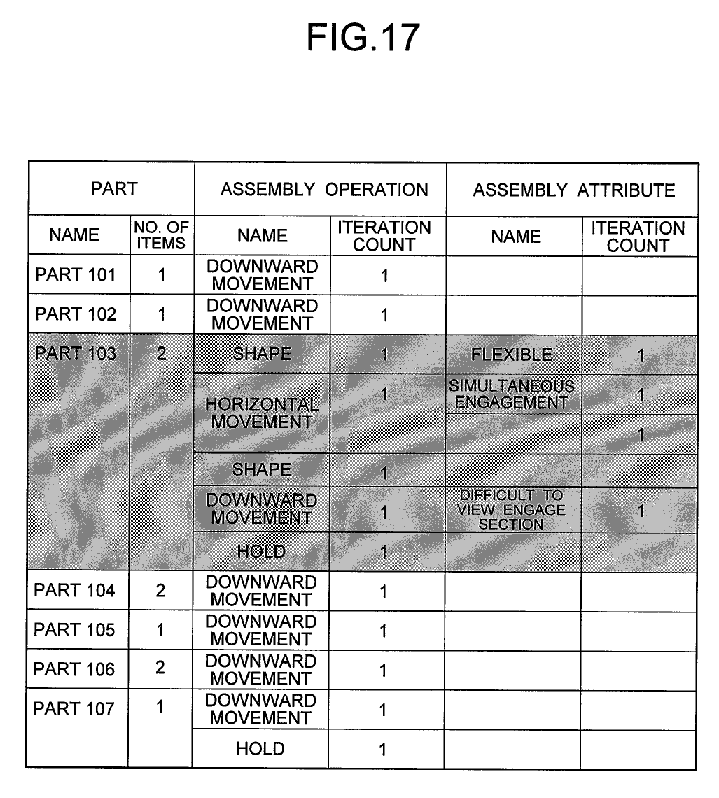

The designer collects the above results in a table as assembly operation analysis data as shown in FIG. 17 and then inputs it to the design support system 1 of FIG. 15 (S301). Incidentally, parts, assembly operations, and assembly attributes in this case are collectively referred to as assembly elements.

### 2. Production Cost Influence Degree Index Calculation

In step S302 of FIG. 15, on the basis of the structural analysis data, the part table data, and the assembly operation analysis data inputted in step S301 and information of the attribute database 41, the assembly easiness database 42, and the defective assembly coefficient database 43; the design support system 1 calculates degrees of influences of the respective structure elements and the respective assembly elements upon the total production cost, the degrees being represented as indices with the total production cost set as 100.

First, the total production cost is calculated. This is the sum of the member costs, the assembly costs, and the defective losses. The member costs are inputted by the designer in the format to be fed to the part table shown in FIG. 4. The assembly costs are calculated on the basis of assembly operation analysis data and the assembly easiness database 42, which will be described later. The defective losses are calculated on the basis of the assembly operation analysis data and the defective assembly coefficient database 43, which will be described later.

Next, description will be given of a method of calculating influence degrees of each of the structure elements and the assembly elements.

### 2.1 Calculation of Production Cost Influence Degree Index of Structure Element

The production cost influence degree index of a structure element is obtained by changing the denominator from the member cost to the production cost in the calculation of the member cost influence degree index of a structure element described in conjunction with the first embodiment. Therefore, in this example, it is assumed that the production cost influence degree index is calculated in the same way as for the member cost influence degree index calculated in FIG. 6.

2.2 Calculation of Production Cost Influence Degree Index Associated with Assembly Element

An influence degree index associated with the assembly cost and an influence degree index associated with the defective loss are separately calculated to be thereafter added to each other.

2.2.1 Production Cost Influence Degree Index Associated with Assembly Cost

The assembly cost and the production cost influence degree index are calculated on the basis of the assembly analysis data of FIG. 17 and the assembly easiness database 42.

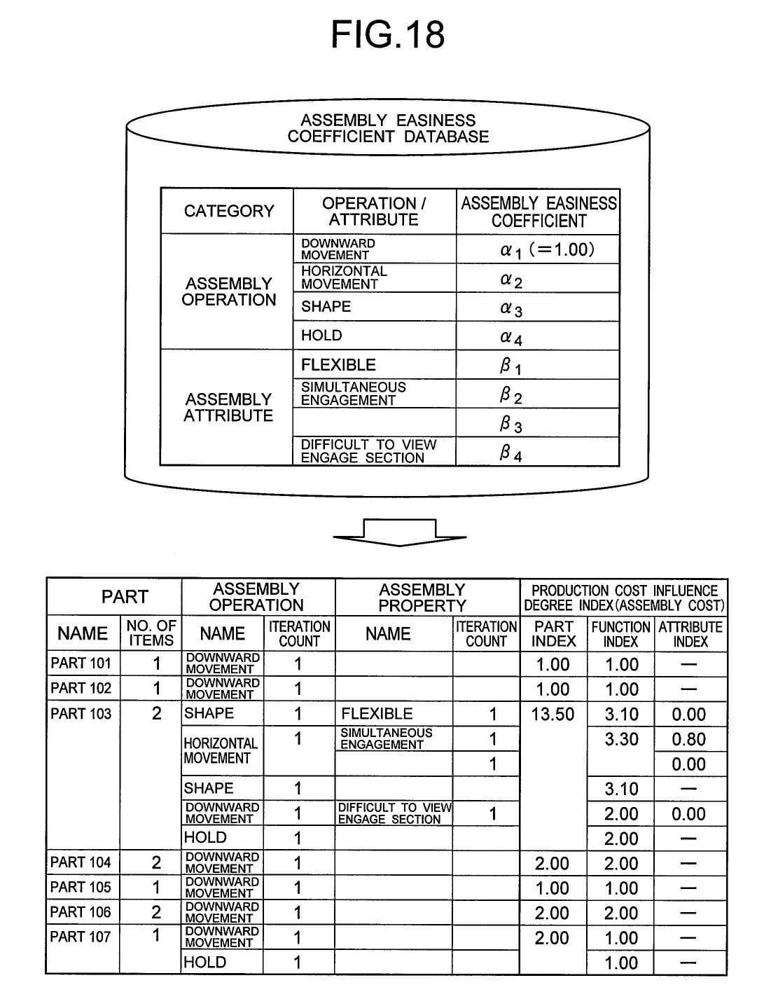

First, description will be given of the assembly easiness database 4 (reference is to be made to FIG. 18). To the database, beforehand defined assembly operations and assembly attributes are registered; and by using, as a reference, the assembly time required to assemble a part of a standard size and a standard weight by a reference assembly operation “downward movement”, the assembly time required in a situation in which the same part is assembled through any other operation is divided by the reference assembly time to calculate and to evaluate the quotient in advance. The quotient is registered as the assembly easiness coefficient to the database 42. Additionally, if any assembly attribute is associated with the index, the coefficient is similarly calculated and evaluated in advance and is registered as the assembly easiness coefficient thereto.

Assume that the assembly time required to assemble a part through the reference assembly operation “downward movement” under a predetermined condition, i.e., “an operator condition, a part condition, a working place condition” (to be referred to as a reference condition) is reference assembly time Ts. Then, the assembly time of a part can be calculated using the following expression.

[assembly time of part]=Σ([reference assembly time Ts]×[assembly easiness coefficient of assembly operation]×[assembly easiness coefficient of assembly attribute] (Expression 5)

This calculation is conducted for all parts constituting the improvement object product and the results are added to each other to obtain the assembly time of the product. Moreover, by multiplying the assembly time by the cost of the working place per hour, there is calculated the assembly cost of the improvement object product.

Next, description will be given of a procedure of calculating the production cost influence degree index associated with the assembly cost.

(1) The difference in the assembly cost due to presence or absence of one part can be regarded as an amount required due to presence of the part. Therefore, a value obtained by multiplying by 100 a value attained by dividing the assembly cost difference by the total production cost is defined as the part index of the production cost influence degree index.
(2) The difference in the assembly cost due to presence or absence of one assembly operation can be regarded as an amount required due to presence of the assembly operation. Therefore, a value obtained by multiplying by 100 a value attained by dividing the assembly cost difference by the total production cost is defined as the assembly operation index of the production cost influence degree index.
(3) The difference in the assembly cost due to presence or absence of one assembly attribute can be regarded as an amount required due to presence of the assembly attribute. Therefore, a value obtained by multiplying by 100 a value attained by dividing the assembly cost difference by the total production cost is defined as the assembly attribute index of the production cost influence degree index.

Next, similarly, for each assembly element of the inputted assembly operation analysis data, the production cost influence degree index associated with the assembly cost is calculated. FIG. 18 shows results of the calculation.

2.2.2 Production Cost Influence Degree Index Associated with Defective Loss

Using the assembly operation analysis data of FIG. 17 and the defective assembly coefficient database 43, the system calculates losses associated with defective assembly and production cost influence degree indices associated with defective losses.

First, description will be given of the defective assembly coefficient database 43. This database is disposed to register thereto defective assembly coefficients calculated as follows. An occurrence rate of defective assembly taking place when a part with a standard size and a standard weight is assembled through the downward movement is employed as a reference. An occurrence rate of defective assembly taking place by adding another assembly operation and another assembly attribute is calculated and is divided by the occurrence rate as the reference to obtain the quotient as the defective assembly coefficient.

Assume that the occurrence rate of defective assembly occurring when a part is assembled through the reference assembly operation “downward movement” under a predetermined condition, i.e., “an operator condition, a part condition, a working place condition” (to be referred to as a reference condition) is reference defective assembly occurrence rate Rs. Then, the defective assembly occurrence rate of a part can be calculated using the following expression.

[defective assembly occurrence rate of a part]=Σ([reference defective assembly occurrence rate Rs]×[defective assembly coefficient of assembly operation]×[defective assembly coefficient of assembly attribute] (Expression 6)

This calculation is conducted for all parts constituting the improvement object product and the results are added to each other to obtain the defective assembly occurrence rate of the product. Moreover, by multiplying the defective assembly occurrence rate by the amount of loss due to defective assembly of the product, there is calculated the defective loss of the product.

Next, description will be given of a procedure of calculating the production cost influence degree index associated with the defective loss.

(1) The difference in the defective loss due to presence or absence of one part can be regarded as an amount required due to presence of the part. Therefore, a value obtained by multiplying by 100 a value attained by dividing the defective loss difference by the total production cost is defined as the part index of the production cost influence degree index.
(2) The difference in the defective loss due to presence or absence of one assembly operation can be regarded as an amount required due to presence of the assembly operation. Therefore, a value obtained by multiplying by 100 a value attained by dividing the defective loss difference by the total production cost is defined as the assembly operation index of the production cost influence degree index.
(3) The difference in the defective loss due to presence or absence of one assembly attribute can be regarded as an amount required due to presence of the assembly attribute. Therefore, a value obtained by multiplying by 100 a value attained by dividing the defective loss difference by the total production cost is defined as the assembly attribute index of the production cost influence degree index.

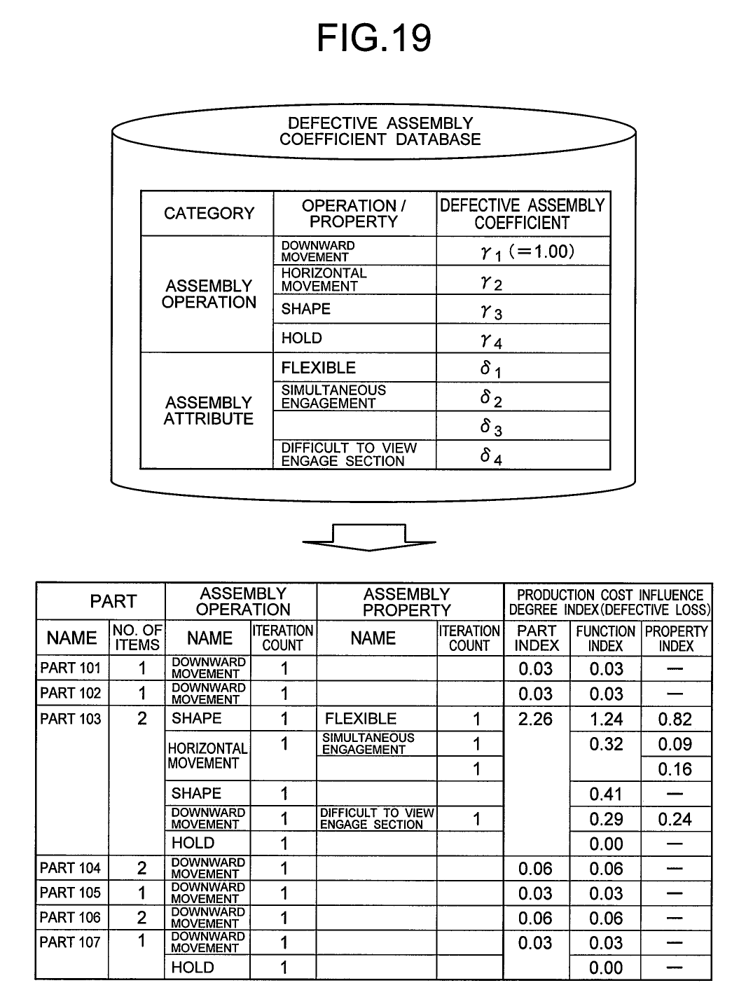

Next, similarly, for each assembly element of the inputted assembly operation analysis data, the production cost influence degree index associated with the defective loss is calculated. FIG. 19 shows results of the calculation.

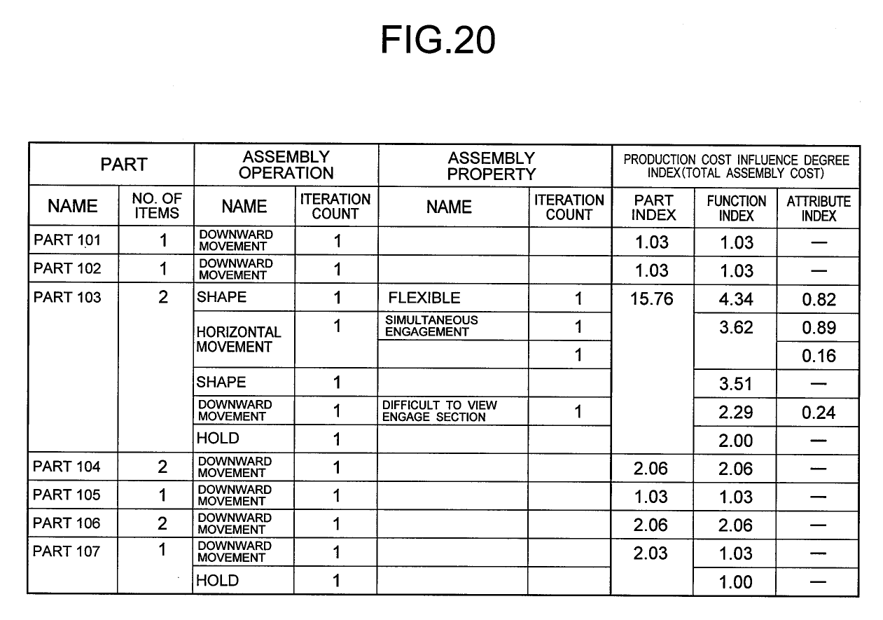

The production cost influence degree index associated with the assembly cost and that associated with the defective loss thus separately calculated are added to each other for each assembly element to obtain the production cost influence degree index associated with the total assembly cost. FIG. 20 shows results of the calculation.

### 3. Improvement Element Extraction

In step S303 of FIG. 15, the design support system 1 extracts structure elements and assembly elements which require improvement on the basis of the production cost influence degree indices calculated in step S302. The procedure will be described.

### 3.1 Extraction of Structure Elements Requiring Improvement

(1) The system adds the member costs to each other until the result of addition exceeds a predetermined threshold and then extracts all parts associated with the addition as parts requiring improvement.
(2) From the functions to be achieved by the parts extracted in (1), the system extracts, as functions requiring improvement, parts whose function index exceeds a predetermined threshold value.
(3) From the attributes making the functions extracted in (2) effective, the system extracts, as attributes requiring improvement, attributes whose attribute index exceeds a predetermined threshold value.

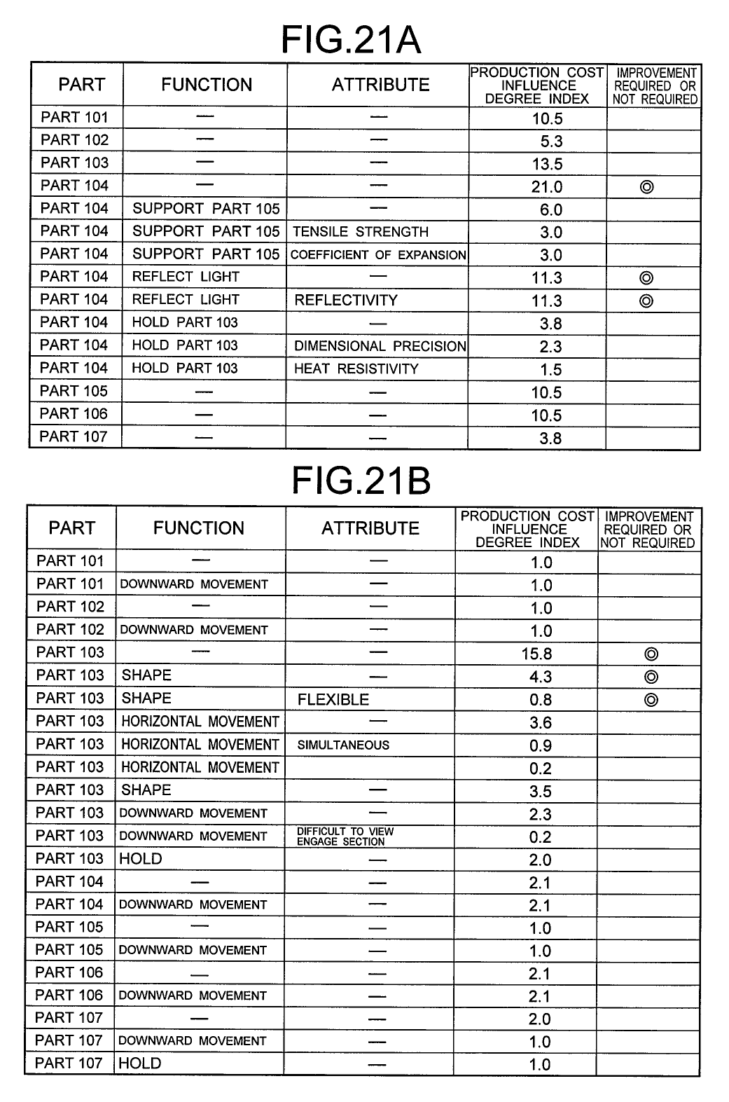

In the example, the system extracts the part 104 as the part requiring improvement, “reflect light” as the function requiring improvement, and “reflectivity” as the attribute requiring improvement. FIG. 21A shows results of the processing.

### 3.2 Extraction of Assembly Element Requiring Improvement

(1) The system adds the part indices to each other until the result of addition exceeds a predetermined threshold and then extracts all parts associated with the addition as parts requiring improvement.
(2) From the assembly operations extracted in (1), the system extracts, as assembly operations requiring improvement, assembly operations whose assembly operations index exceeds a predetermined threshold value.
(3) From the operation attributes associated with the assembly operations extracted in (2), the system extracts, as attributes requiring improvement, attributes whose attribute index exceeds a predetermined threshold value.

In the example, the system extracts the part 103 as the part requiring improvement, “shape” as the assembly operation requiring improvement, and “flexibility” as the assembly attribute requiring improvement. FIG. 21B shows results of the processing.

If it is desired only to extract elements requiring improvement, the design support system 1 displays in step S304 of FIG. 15 the structure elements and the assembly elements which require improvement and which are extracted in step S303 as shown in FIGS. 21A and 21B. In step S305 of FIG. 15, by referring to the results of FIGS. 21A and 21B, the designer can efficiently detect the structure elements and the assembly elements requiring improvement to reduce the production cost. It is hence possible to reduce the design time.

If it is desired to extract improvement guidelines, the system proceeds from step S303 to step S306 without conducting steps S304 and S305 of FIG. 15.

### 4. Improvement Guideline Creation

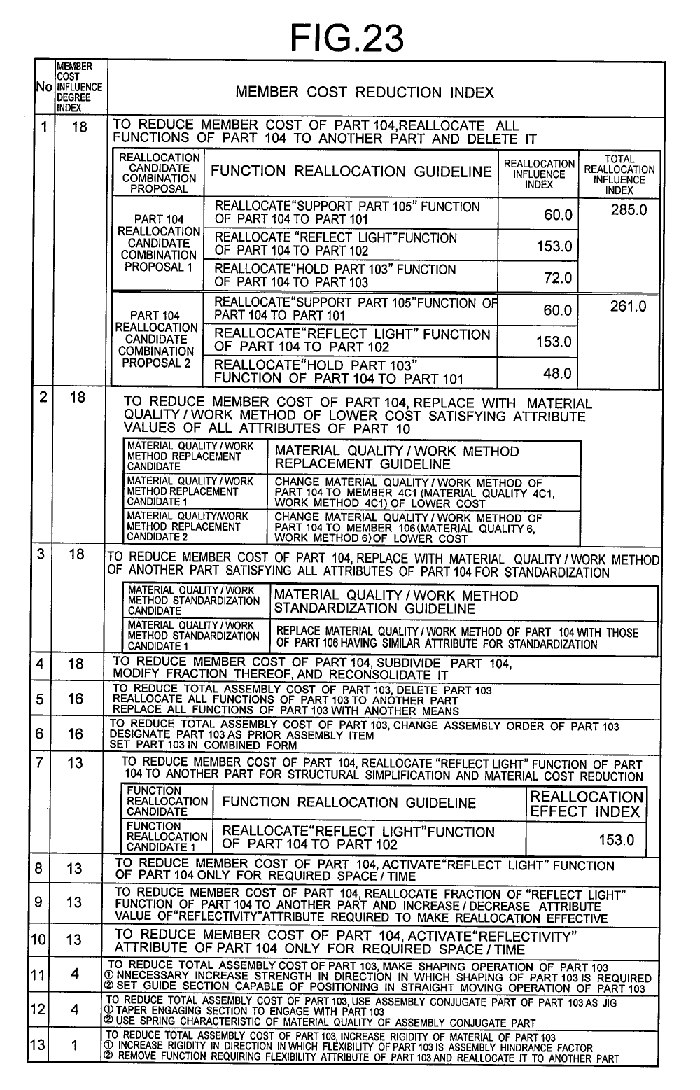

In step S306 of FIG. 15, the design support system 1 creates an improvement guideline for the structure elements and the assembly elements requiring improvement extracted in step S303 as shown in FIG. 23.

The improvement guideline associated with structure elements is created according to the input data and the member cost improvement guideline configuring database 44. The creation of the improvement guideline is carried out through a procedure similar to that of the first embodiment of the present invention. Incidentally, details of the contents (no. 1 to no. 4; no. 7 to no. 10) of improvement guidelines associated with structure elements are similar to those of the first embodiment, and hence description thereof will be avoided.

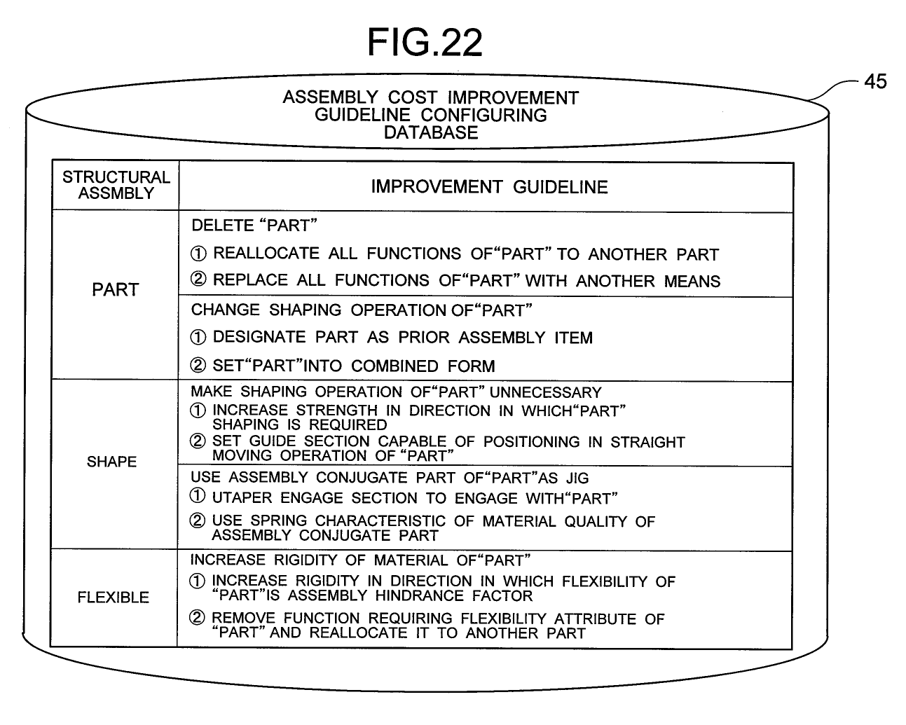

The improvement guideline associated with assembly elements is created according to the input data and the total assembly cost improvement guideline configuring database 45. As FIG. 22 shows, the database 45 establishes a correspondence between improvement guidelines obtained by abstracting various improvement examples in the past and the assembly elements as improvement objects. The improvement guideline can be configured by inserting associated words of the input data in fields enclosed by brackets of the database 45.

Next, description will be given of the contents of improvement guidelines associated with assembly elements in FIG. 23.

First, description will be given of No. 5 “To reduce total assembly cost, delete part 103”. First, the improvement target is clarified. In this situation, “part 103” as the improvement object part is combined with “to reduce total assembly cost” as the improvement target. Next, from the total assembly cost improvement guideline configuring database 45, “delete “part”” as the part improvement guideline is extracted and is then combined with “part 103” as the improvement object part. Reduction of parts is important also when the total assembly cost is to be reduced. As methods for the reduction, there can be considered methods such as [1] method of reallocating all functions of part to another part and [2] method of changing needles of clock to liquid-crystal display.

No. 6 “To reduce total assembly cost, change assembly order of part 103” is implemented by combining “change assembly order of “part” as the part improvement guideline extracted from the database 45 with “part 103” as the improvement object part. It occurs in many cases that a part which is difficult to be assembled after other parts are assembled can be relatively easily assembled if it is assembled before other parts. Particularly, for a flexible part, it is important that the part is assembled onto a stabled part in a possibly early stage.

No. 11 “To reduce total assembly cost, make shaping operation of part 103 unnecessary”, is implemented by combining “make shaping operation of “part” unnecessary” as the part improvement guideline of the assembly operation “shape” extracted from the total assembly cost improvement configuring database 45 with “part 103” as the improvement object part. For the shaping operation, there exist a case to shape a part whose contour is not fixed such as a part of rubber and a case to align a relative position and a relative angle between an assembly part and a conjugate assembly part. If strength of a part whose contour is not fixed is increased in other than a direction requiring flexibility, efficiency of assembly is improved. In addition, for the assembly of a part requiring the positioning, there is effectively employed a method in which a guide section is disposed in either one of the assembly part and the conjugate assembly part to achieve the positioning through a straight moving operation.

No. 12 “To reduce total assembly cost of part 103, use assembly conjugate part of part 103 as jig” is implemented by combining “use assembly conjugate part of part 103 as jig” as the part improvement guideline of the assembly operation “shape” extracted from the database 45 with “part 103” as the improvement object part. In a situation in which an assembly part is positioned through the shaping operation to be thereafter assembled with the assembly conjugate part, there is effectively employed in the assembly part or the assembly conjugate part, a guide section or structure which is retracted only in the assembly.

No. 13 “To reduce total assembly cost, increase rigidity of material of part 103” is implemented by combining “increase rigidity of material of “part” as the part improvement guideline of the assembly attribute “flexible” extracted from the database 45 with “part 103” as the improvement object part. There is effectively used a method to increase rigidity of material in which [1] interfere with another part at assembly, [2] clarify the fundamental reason for the requirement of flexibility, for example, to flexibly support a delicate part, [3] take measures, for example, change structure to remove interference with another part and reallocate functions requiring flexibility to another part.

In step S307 of FIG. 15, the design support system 1 displays the improvement guidelines created in step S306 on a display.

In step S308 of FIG. 15, the designer can efficiently create improvement structure by referring to the improvement guidelines presented on the display.

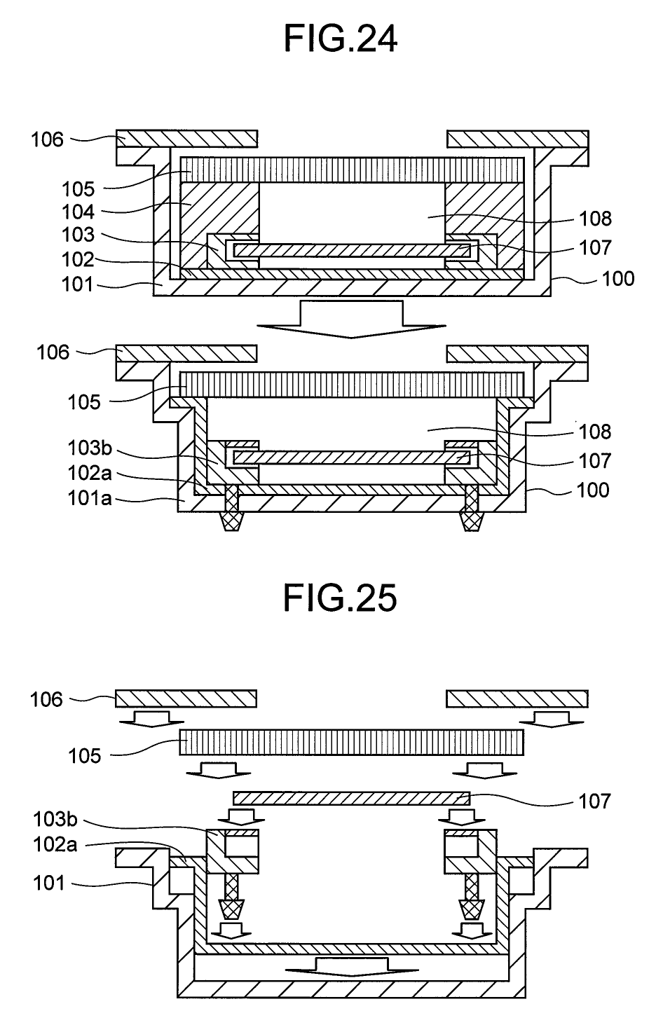

FIG. 24 shows an improvement structure creation example. Also, FIG. 25 shows an assembly operation. This is a structure creation example in which three functions to be achieved by the part 104 are entirely reallocated to other parts and the part 104 is deleted to resultantly improve the attribute of assembly of the part 103.

(1) The “support part 105” function of the part 104 is designated in structure in which on the basis of improvement guideline no. 1, combination proposal 1 “reallocate “support part 105” function of part 104 to part 101”, “dispose crank-shaped receiving section to support part 105 on upper section of part 101 to support part 105 by receiving section”.
(2) The “reflect light” function of the part 104 is designated in structure in which on the basis of improvement guideline no. 1, combination proposal 1 “reallocate “reflect light” function of part 104 to part 102”, “extend both ends of part 102 and bend both sides to reflect light on both side surfaces”.
(3) The “support part 103” function of the part 104 is designated in structure in which on the basis of improvement guideline no. 1, combination proposal 1 “reallocate “support part 103” function of part 104 to part 103”, “dispose projection to engage with part 101 on lower section of part 103 to hold part 103 itself by projection”.
(4) The part 103 is designated in structure in which on the basis of improvement guideline no. 6 “designate part 103 as prior assembly item”, “without setting in combination with part 107 which is delicate and which cannot be worked, and assemble in advance with part 101 stable as structure part”.
(5) The “shaping” operation of the part 103 is designated in structure in which on the basis of improvement guideline no. 12 “Taper engage section to engage with part 103” and “Use spring characteristic of material quality of assembly part/assembly conjugate part”, “dispose slit on upper section of part 103 to assemble part 107 through downward movement from above”. In association therewith, there is designated a structure in which the slit section of the part 103 is tapered to improve positioning efficiency; moreover, the part 103 widely opens at assembly to facilitate the assembly of the part 107 and closes after the assembly to support the part 107.
(6) The “flexible” attribute of the part 103 is designated in structure in which on the basis of improvement guideline no. 13 “increase rigidity of material of part 103”, “change from lubber to resin by improving complex assembly operation requiring flexibility”.

As above, according to the present invention, there can be attained improvement guidelines of structure elements and assembly elements having a high member cost reduction effect only by inputting the structural analysis data and the assembly operation analysis data, and it is hence possible to improve efficiency of the production cost reduction design.

It should be further understood by those skilled in the art that although the foregoing description has been made on embodiments of the invention, the invention is not limited thereto and various changes and modifications may be made without departing from the spirit of the invention and the scope of the appended claims.

1. A design support method of presenting, for a product design proposal of an improvement object product, guidelines of improvement to reduce member costs of the product, comprising:
an attribute database saving step of beforehand saving, as a database, attributes, attribute values, and material•work method costs of members implemented by using various materials and work methods thereof;
a step of receiving, in the product design proposal, inputs of structural analysis data representing constituent parts of the product, a function of each part acting upon another part, and attributes possessed by respective parts to make the functions effective and part table data including materials, work methods, and member costs of the respective constituent parts;
a step of calculating; on the basis of the structural analysis data, the part table data, and information from the attribute database; a member cost influence degree index representing a degree of influence of each of the parts, the functions, and the attributes constituting the improvement object product upon a total of member costs of all parts constituting the improvement object product;
a step of setting a reduction target value T_{tc} of the total of the member costs of the improvement object product;
a step of comparing the member costs of the respective parts constituting the improvement object product with each other, adding the member costs to each other in a descending order of the member costs, terminating the addition when a sum of the addition reaches the reduction target value T_{tc}, and extracting, as improvement object parts, the parts associated with the addition;
a step of extracting, as improvement object functions, functions having a function index equal to or more than a predetermined threshold value from functions of the improvement object parts thus extracted;
a step of extracting, as improvement object attributes, attributes having an attribute index equal to or more than a predetermined threshold value from attributes which make the improvement object functions thus extracted effective; and
a presenting step of displaying results of the steps described above on a display, thereby presenting the results.

2. A design support method according to claim 1, further comprising:
a member cost improvement guideline configuring database saving step of saving, as a database, improvement guidelines of respective functions and respective attributes determined to reduce member costs on the basis of many design examples in the past;
a step of extracting, from the member cost improvement guideline configuring database, improvement guidelines associated with the improvement object parts, the improvement object functions, and the improvement object attributes thus extracted;
an improvement guideline creation step of creating specific guidelines on the basis of the improvement guidelines thus extracted and parts, functions, and attributes associated therewith; and
a presenting step of displaying results of the steps described above on a display, thereby presenting the results.

3. A design support system for presenting, for a product design proposal of an improvement object product, guidelines of improvement to reduce member costs of the product, comprising:
an attribute database having beforehand saved attributes, attribute values, and material•work method costs of members implemented by using various materials and work methods thereof;
input unit for receiving, in the product design proposal, inputs of structural analysis data representing constituent parts of the product, a function of each part acting upon another part, and attributes possessed by respective parts to make the functions effective and part table data including materials, work methods, and member costs of the respective constituent parts;
operating unit for
(1) calculating; on the basis of the structural analysis data, the part table data, and information from the attribute database; a member cost influence degree index representing a degree of influence of each of the parts, the functions, and the attributes constituting the improvement object product upon a total of member costs of all parts constituting the improvement object product;
(2) receiving a reduction target value T_{tc} of the total of the member costs of the improvement object product from the input unit and setting the reduction target value T_{tc};
(3) comparing the member costs of the respective parts constituting the improvement object product with each other, adding the member costs to each other in a descending order of the member costs, terminating the addition when a sum of the addition reaches the reduction target value T_{tc}, and extracting, as improvement object parts, the parts associated with the addition;
(4) extracting, as improvement object functions, functions having a function index equal to or more than a predetermined threshold value from functions of the improvement object parts thus extracted; and
(5) extracting, as improvement object attributes, attributes having an attribute index equal to or more than a predetermined threshold value from attributes which make the improvement object functions thus extracted effective; and
presenting unit for displaying results of the steps described above on a display, thereby presenting the results.

4. A design support system according to claim 3, comprising a member cost improvement guideline configuring database for beforehand saving improvement guidelines of respective functions and respective attributes determined to reduce member costs on the basis of many design examples in the past, wherein:
the operating unit further extracts, from the member cost improvement guideline configuring database, improvement guidelines associated with the improvement object parts, the improvement object functions, and the improvement object attributes thus extracted;
the operating unit creates specific guidelines on the basis of the improvement guidelines thus extracted and parts, functions, and attributes associated therewith; and
the presenting unit further displays results of the steps described above on a display.

5. A design support method of presenting, for a product design proposal of an improvement object product, guidelines of improvement to reduce member costs of the product, comprising:
an attribute database saving step of beforehand saving, as a database, attributes, attribute values, and material•work method costs of members implemented by using various materials and work methods thereof;
an assembly easiness coefficient database saving step of beforehand saving, in an assembly easiness coefficient database, coefficients indicating degrees of assembly easiness of each of the assembly operations determined on the basis of many design examples in the past and each of the assembly attributes associated with the assembly operations;
a defective assembly coefficient database saving step of beforehand saving, in a defective assembly coefficient database, coefficients indicating degrees of defective assembly potential of each of the assembly operations determined on the basis of many design examples in the past and each of the assembly attributes associated with the assembly operations;
a step of receiving, in the product design proposal, inputs of structural analysis data representing constituent parts of the product, a function of each part acting upon another part, and attributes possessed by respective parts to make the functions effective; part table data including materials, work methods, and member costs of the respective constituent parts, and assembly operation analysis data representing constituent parts of the product, assembly operations of the respective parts, and assembly attributes associated with the assembly operations;
an operation step of calculating; on the basis of attribute values and costs of various material•work methods read from the attribute database, assembly easiness coefficients read from the assembly easiness coefficient database, and defective assembly coefficients read from the defective assembly coefficient database; production cost influence degree indices indicating influences of the constituent parts, the functions, the attributes, and the assembly attributes of the product design proposal upon a production cost obtained by totaling the member costs, the assembly costs, and costs of losses due to defective assemblies; and
a presenting step of displaying results of the steps described above on a display.

6. A design support method according to claim 5, further comprising:
a member cost improvement guideline configuring database saving step of beforehand saving, as a database, improvement guidelines of respective functions and respective attributes determined to reduce member costs on the basis of many design examples in the past;
an assembly cost improvement guideline database saving step of beforehand saving, as a database, the assembly operations and the assembly attributes determined on the basis of many design examples in the past and improvement guidelines of the assembly operations and the assembly attributes to reduce the assembly time;
an assembly cost improvement guideline database saving step of beforehand saving, as an assembly cost improvement guideline database, the assembly operations and the assembly attributes determined on the basis of many design examples in the past and improvement guidelines of the assembly operations and the assembly attributes to reduce the defective assemblies;
a selection step of selecting parts, functions, and attributes having a high production cost influence degree index;
a step of extracting, from the databases, improvement guidelines associated with the parts, functions, attributes, the assembly operations, and assembly attributes selected as above;
an improvement guideline creation step of creating specific improvement guidelines on the basis of the improvement guidelines thus extracted and the parts, the functions, and the attributes associated therewith; and
a presenting step of displaying results of the steps described above on a display, thereby presenting the results.

7. A design support system for presenting, for a product design proposal of an improvement object product, guidelines of improvement to reduce member costs of the product, comprising:
an attribute database having beforehand saved, as an attribute database, attributes, attribute values, and material•work method costs of members implemented by using various materials and work methods thereof;
an assembly easiness coefficient database for beforehand saving coefficients indicating degrees of assembly easiness of each of the assembly operations determined on the basis of many design examples in the past and each of the assembly attributes associated with the assembly operations;
a defective assembly coefficient database for beforehand saving coefficients indicating degrees of defective assembly potential of each of the assembly operations determined on the basis of many design examples in the past and each of the assembly attributes associated with the assembly operations;
input unit for receiving, in the product design proposal, inputs of structural analysis data representing constituent parts of the product, a function of each part acting upon another part, and attributes possessed by respective parts to make the functions effective; part table data including materials, work methods, and member costs of the respective constituent parts, and assembly operation analysis data representing constituent parts of the product, assembly operations of the respective parts, and assembly attributes associated with the assembly operations;
operation unit for calculating; on the basis of attribute values and costs of various material•methods read from the attribute database, assembly easiness coefficients read from the assembly easiness coefficient database, and defective assembly coefficients read from the defective assembly coefficient database; production cost influence degree indices indicating influences of the constituent parts, the functions, the attributes, and the assembly attributes of the product design proposal upon a production cost obtained by totaling the member costs, the assembly costs, and costs of losses due to defective assemblies; and
presenting unit for displaying results of the steps described above on a display.

8. A design support system according to claim 7, further comprising:
a member cost improvement guideline database for beforehand saving improvement guidelines of respective functions and respective attributes determined to reduce member costs on the basis of many design examples in the past;
an assembly cost improvement guideline database for beforehand saving the assembly operations and the assembly attributes determined on the basis of many design examples in the past and improvement guidelines of the assembly operations and the assembly attributes to reduce the assembly time; and
an assembly cost improvement guideline database for beforehand saving the assembly operations and the assembly attributes determined on the basis of many design examples in the past and improvement guidelines of the assembly operations and the assembly attributes to reduce the defective assemblies, wherein;
the operation unit further selects parts, functions, and attributes having a high production cost influence degree index,
extracts, from the databases, improvement guidelines associated with the parts, functions, attributes, the assembly operations, and assembly attributes selected as above, and
creates specific improvement guidelines on the basis of the improvement guidelines thus extracted and the parts, the functions, and the attributes associated therewith; and
the presenting unit displays results of the steps described above on a display.

9. A design support method according to claim 2, wherein the improvement guideline creation step comprises:
a step of evaluating adjacency of an improvement object part to other parts constituting the product;
a step of evaluating similarity of an attribute possessed by an improvement object part with attributes possessed by other parts;
a step of evaluating, on the basis of the adjacency and the attribute similarity, function reallocatability of a function of an improvement object part to other parts; and
a presenting step of displaying results of the steps described above on a display, thereby presenting the results.

10. A design support method according to claim 6, wherein the improvement guideline creation step comprises:
a step of evaluating adjacency of an improvement object part to other parts constituting the product;
a step of evaluating similarity of an attribute possessed by an improvement object part with attributes possessed by other parts;
a step of evaluating, on the basis of the adjacency and the attribute similarity, function reallocatability of a function of an improvement object part to other parts; and
a presenting step of displaying results of the steps described above on a display, thereby presenting the results.

11. A design support method according to claim 2, wherein the improvement guideline creation step comprises:
a step of calculating, according to CAD data, a shortest distance between an improvement object part and other parts constituting the product;
a step of classifying and evaluating adjacency of an improvement object part to other parts constituting the product on the basis of the shortest distance;
a step of evaluating similarity of an attribute possessed by an improvement object part with attributes possessed by other parts;
a step of evaluating, on the basis of the adjacency and the attribute similarity, function reallocatability of a function of an improvement object part to other parts; and
a presenting step of displaying results of the steps described above on a display, thereby presenting the results.

12. A design support method according to claim 6, wherein the improvement guideline creation step comprises:
a step of calculating, according to CAD data, a shortest distance between an improvement object part and other parts constituting the product;
a step of classifying and evaluating adjacency of an improvement object part to other parts constituting the product on the basis of the shortest distance;
a step of evaluating similarity of an attribute possessed by an improvement object part with attributes possessed by other parts;
a step of evaluating, on the basis of the adjacency and the attribute similarity, function reallocatability of a function of an improvement object part to other parts; and
a presenting step of displaying results of the steps described above on a display, thereby presenting the results.

13. A design support method according to claim 2, wherein the improvement guideline creation step comprises:
a step of evaluating adjacency of an improvement object part to other parts constituting the product;
a step of evaluating similarity of an attribute possessed by an improvement object part with attributes possessed by other parts;
a step of evaluating, on the basis of the adjacency and the attribute similarity, function reallocatability of a function of an improvement object part to other parts;
a step of evaluating reallocatability of all functions of an improvement object part to other parts on the basis of a total of values of the function reallocatability evaluation of all combinations of the parts whose functions are evaluated as reallocatable; and
a presenting step of displaying results of the steps described above on a display, thereby presenting the results.

14. A design support method according to claim 2, wherein the improvement guideline creation step comprises:
a step of evaluating adjacency of an improvement object part to other parts constituting the product;
a step of evaluating similarity of an attribute possessed by an improvement object part with attributes possessed by other parts;
a step of evaluating, on the basis of the adjacency and the attribute similarity, function reallocatability of a function of an improvement object part to other parts;
a step of evaluating reallocatability of all functions of an improvement object part to other parts on the basis of a total of products between values of the function reallocatability of all combinations of the parts whose functions are evaluated as reallocatable and the member cost influence degree indices with respect to the functions; and
a presenting step of displaying results of the steps described above on a display, thereby presenting the results.
